(19) United States
(12) Patent Application Publication
(10) Pub. No.: US 2022/0160470 A1
(43) Pub. Date: May 26, 2022

(54) ALIGNER STRESS MEASUREMENT USING FLUORESCENCE

(71) Applicant: Align Technology, Inc., San Jose, CA (US)

(72) Inventors: Michael Christopher COLE, San Jose, CA (US); Huizhong LI, San Jose, CA (US); Jun SATO, San Jose, CA (US); Yuxiang WANG, Newark, CA (US)

(21) Appl. No.: 17/531,669

(22) Filed: Nov. 19, 2021

Related U.S. Application Data
(60) Provisional application No. 63/116,515, filed on Nov. 20, 2020.

(51) Int. Cl. A61C 7/10; B33Y 80/00; B33Y 70/00; B33Y 10/00

(52) U.S. Cl. CPC A61C 7/10; B33Y 10/00; B33Y 70/00; B33Y 80/00

(57) ABSTRACT

The disclosure provides resins, polymeric materials, and devices incorporating force probes. Advantageously, the force probes emit an emission useful for determining the amount of force or stress applied to a material incorporated with force probes. Further, the present disclosure provides methods of detecting forces and stress applied to force probe incorporated materials. Materials such as orthodontic appliances comprising force probes possess particular advantage and utility as measurement of the emission of the orthodontic appliance(s) from a patient can aid in evaluating treatment progress.

### CROSS-REFERENCE

This application claims the benefit of U.S. Provisional Patent Application No. 63/116,515, filed Nov. 20, 2020, the contents of which is incorporated herein by reference in their entirety.

### BACKGROUND OF THE INVENTION

Force probes are useful for detecting stress changes in a local environment by measuring changes in emission wavelength. These force probes are particularly useful in materials that require life-cycle management to identify the longevity or use of a material. This property is advantageous to orthodontic procedures which typically involve repositioning a patient's teeth to a desired arrangement. Specifically, orthodontic appliances (e.g braces, retainers, shell aligners, and the like) are configured to exert force on one or more teeth in order to effect desired tooth movements in a patient. During orthodontic treatment, stress data can be collected from the force probe incorporated orthodontic appliance by measuring the emission and determining whether a patient is ready to move on to the next orthodontic appliance in series of orthodontic appliances. Resins and polymeric materials that incorporate force probes can be used to fabricate devices or objects whose emission wavelengths can be collected to determine the stress applied to the device or object.

### SUMMARY OF THE INVENTION

Provided herein are resins, polymeric materials, and devices comprising force probes. Such materials have advantageous emission properties useful for determining the stress or force applied to the force probe incorporated materials. Also provided herein are objects manufactured using the force probes incorporated polymeric materials, resins for forming the polymeric materials and objects made therefrom, and methods of forming and using the polymeric materials. Further provided herein are methods for detecting stress and methods for detecting forces in such materials incorporating force probes.

In various aspects, the present disclosure provides an orthodontic appliance comprising a polymeric material; and a force probe incorporated into the polymeric material. In some embodiments, the force probe when in an unstrained configuration comprises a first emission spectrum, and when in a strained configuration comprises a second emission spectrum, wherein the first emission spectrum and the second emission spectrum are distinct from one another. In some embodiments, the transition between the first emission spectrum and the second emission spectrum occurs when a mechanical force is applied to the orthodontic appliance. In some embodiments, the mechanical force comprises application of the orthodontic appliance to a patient's teeth. In some embodiments, the force probe comprises a detectable fluorophore, the detectable fluorophore having an emission spectrum. In some embodiments, the detectable fluorophore has a first detectable emission responsive to a first contact force and a second detectable emission responsive to a second contact force. In some embodiments, the transition between the first detectable emission and the second detectable emission occurs when a mechanical force is applied to the orthodontic appliance. In some embodiments, the orthodontic appliance comprises a localized region, the localized region comprising: the force probe, at least some of the polymeric material; and an area less than 100 nm in any direction from the force probe wherein the mechanical force comprises a force greater than 1 pN applied to the localized region. In some embodiments, the transition between the first emission spectrum and the second emission spectrum occurs when the mechanical force is applied. In some embodiments, the force probe further comprises a photon absorber. In some embodiments, the photon absorber is a quencher. In some embodiments, the detectable fluorophore has an emission spectrum that overlaps with an absorption spectrum of the quencher. In some embodiments, at least 10% of an area of the absorption spectrum of the quencher overlaps with the emission spectrum of the detectable fluorophore. In some embodiments, the quencher comprises 4-(dimethylaminoazo)benzene-4-carboxylic acid, a DDQ quencher, a BHQ quencher, a QSY quencher, a derivative thereof, or a combination thereof. In some embodiments, the photon absorber is a second fluorophore. In some embodiments, the detectable fluorophore has an emission spectrum that overlaps with an absorption spectrum of the second fluorophore. In some embodiments, at least 10% of an area of the absorption spectrum of the second fluorophore overlaps with the emission spectrum of the detectable fluorophore. In some embodiments, the second fluorophore comprises a xanthene derivative, a cyanine derivative, a squaraine derivative, a naphthalene derivative, a coumarin derivative, an oxadiazole derivative, an anthracene derivative, a pyrene derivative, an oxazine derivative, an acridine derivative, an arylmethine derivative, a tetrapyrrole derivative, or a combination thereof. In some embodiments, the detectable fluorophore comprises a xanthene derivative, a cyanine derivative, a squaraine derivative, a naphthalene derivative, a coumarin derivative, an oxadiazole derivative, an anthracene derivative, a pyrene derivative, an oxazine derivative, an acridine derivative, an arylmethine derivative, a tetrapyrrole derivative, or a combination thereof. In some embodiments, the photon absorber is coupled to the detectable fluorophore. In some embodiments, the force probe comprises a flexible tether, and wherein the photon absorber and the detectable fluorophore are each coupled to the flexible tether. In some embodiments, the flexible tether comprises a polymer chain or a peptide chain. In some embodiments, the flexible tether comprises polyethylene glycol. In some embodiments, the photon absorber and the detectable fluorophore have a Förster distance. In some embodiments, the distance between the detectable fluorophore and the photon absorber in the orthodontic appliance at rest is at most 1.5-fold the Förster distance. In some embodiments, the distance between the detectable fluorophore and the photon absorber is at least 0.5-fold the Förster distance when the mechanical force is applied to the orthodontic appliance. In some embodiments, the detectable fluorophore comprises a single-molecule force probe. In some embodiments, the single-molecule force probe is selected from the group consisting of a spiropyran, an aromatic disulfide, a nitroxyl, a stilbene, and a dye. In some embodiments, the force probe is luminescent. In some embodiments, the force probe is fluorescent or phosphorescent. In some embodiments, the force probe is coupled to the polymeric material. In some embodiments, the force probe is incorporated into the backbone of the polymeric material. In some embodiments, the detectable fluorophore is coupled to the polymeric material, and wherein the photon absorber is attached to a second polymeric material. In some embodiments, the detectable fluorophore and the photon absorber are separated by a distance of at most 10 nm when the orthodontic appliance is at rest. In some embodiments, the force probe is intermixed with the polymeric material. In some embodiments, the force probe is coupled to the polymeric material by hydrogen bonding. In some embodiments, the transition between the first detectable emission and the second detectable emission comprises a change in the maximum emission wavelength. In some embodiments, the change in the maximum emission wavelength is at least 20 nm. In some embodiments, the orthodontic appliance comprises at most 5 wt % of the force probe. In some embodiments, the transition between the first detectable emission and the second detectable emission corresponds with the mechanical force that is applied to the orthodontic appliance. In some embodiments, the transition between the first detectable emission and the second detectable emission corresponds linearly with the mechanical force that is applied to the orthodontic appliance. In some embodiments, the orthodontic appliance is an aligner, expander, spacer, or any combination thereof. In some embodiments, the orthodontic appliance comprises a plurality of tooth receiving cavities configured to reposition teeth from a first configuration toward a second configuration. In some embodiments, the orthodontic appliance is one of a plurality of orthodontic appliances configured to reposition the teeth from an initial configuration toward a target configuration. In some embodiments, the orthodontic appliance is one of a plurality of orthodontic appliances configured to reposition the teeth from an initial configuration toward a target configuration according to a treatment plan.

In various aspects the present disclosure provides an orthodontic appliance comprising a polymeric material and a force probe incorporated into the polymeric material, wherein the force probe, when in an unstrained configuration comprises a first emission spectrum, and when in a strained configuration comprises a second emission spectrum, wherein the first emission spectrum and the second emission spectrum are distinct from one another, wherein a transition between the unstrained configuration and the strained configuration occurs when a force is applied to the orthodontic appliance. In some aspects, the force comprises a mechanical force comprising application of the orthodontic appliance to a patient's teeth. In some aspects, the polymeric material comprises a plurality of additively formed layers. In some aspects, the polymeric material comprises a thermoplastic material.

In various aspects the present disclosure provides an orthodontic appliance comprising a polymeric material and means for probing an emission spectrum of the polymeric material, wherein the means for probing comprises a first emission spectrum when in an unstrained configuration, and the means for probing comprises a second emission spectrum when in a strained configuration, wherein the first emission spectrum and the second emission spectrum are distinct from one another, wherein a transition between the unstrained configuration and the strained configuration occurs when a force is applied to the orthodontic appliance.

In various aspects the present disclosure provides a kit comprising: an orthodontic appliance as disclosed herein, and a case, the case comprising a light emitting source, and a detector. In some embodiments, the light emitting source emits at least one wavelength. In some embodiments, the detector is an optical detector. In some embodiments, the optical detector is selected from the group consisting of a charge-coupled device, an active-pixel sensor, a contact image sensor, an electro-optical sensor, an infra-red sensor, a kinetic inductance detector, a light emitting diode, a light-addressable potentiometric sensor, a fiber optic sensor, a thermopile laser sensor, a photodetector, a photodiode, a photomultiplier, a phototransistor, a photoelectric sensor, a photoionization detector, a photomultiplier, a photoresistor, a photoswitch, a phototube, a single-photon avalanche diode, a visible-light photon counter, and a wavefront sensor. In some embodiments, the optical detector comprises a camera. In some embodiments, the detector detects at least one wavelength. In some embodiments, the kit further provides instructions.

In various aspects the present disclosure provides a resin comprising: an oligomer, a force probe, and a photoinitiator. In some embodiments, the resin comprises 0.01-5 wt % of the force probe. In some embodiments, the resin further comprising a reactive diluent, a crosslinking modifier, a light blocker, a thermal initiator, or any combination thereof.

In various aspects the present disclosure provides a method of forming a polymeric material, the method comprising providing a resin as disclosed herein, and curing the resin with a light source, thereby forming a polymeric material. In some embodiments, the method further comprises fabricating an object with the polymeric material. In some embodiments, the object is an orthodontic appliance as disclosed herein. In some embodiments, the orthodontic appliance is an aligner, expander, spacer, or any combination thereof. In some embodiments, the orthodontic appliance comprises a plurality of tooth receiving cavities configured to reposition teeth from a first configuration toward a second configuration. In some embodiments, the orthodontic appliance is one of a plurality of orthodontic appliances configured to reposition the teeth from an initial configuration toward a target configuration. In some embodiments, the orthodontic appliance is one of a plurality of orthodontic appliances configured to reposition the teeth from an initial configuration toward a target configuration according to a treatment plan. In some embodiments, the fabricating comprises printing with a 3D printer. In some embodiments, the fabricating comprises hot lithography. In some embodiments, the fabricating comprises digital light projection.

In various aspects the present disclosure provides a method of detecting a force on an orthodontic appliance, the method comprising: providing the orthodontic appliance as disclosed herein, and detecting an emission from the force probe. In some embodiments, the orthodontic appliance comprises a plurality of force probes, each comprising a detectable emission that changes when a mechanical force is applied to the orthodontic appliance. In some embodiments, the mechanical force comprises application of the orthodontic appliance to a patient's teeth. In some embodiments, detecting the emission from the force probe provides a measure of the mechanical force. In some embodiments, detecting the emission from the force probe informs a user to continue application of the orthodontic appliance to the patient's teeth or to apply a next orthodontic appliance from a sequence of orthodontic appliances to the patient's teeth. In some embodiments, the mechanical force comprises bonding the orthodontic appliance to the patient's teeth. In some embodiments, the mechanical force comprises testing the orthodontic appliance during manufacture. In some embodiments, testing the orthodontic appliance occurs during or after orthodontic appliance removal during manufacture. In some embodiments, the detectable emission informs on warpage or breakage of the orthodontic appliance. In some embodiments, detecting the emission from the force probe informs on an amount of stress imposed onto the orthodontic appliance. In some embodiments, detecting the emission from the force probe informs on rate of relaxation of the orthodontic appliance in combination with tooth movement. In some embodiments, detecting the detectable emission from the force probe comprises detecting the detectable emission from at least some of the plurality of force probes. In some embodiments, the change in detectable emission corresponds with the mechanical force applied to the orthodontic appliance. In some embodiments, the change in detectable emission corresponds linearly with the mechanical force that is applied to the orthodontic appliance. In some embodiments, the method further comprises measuring the change in the detectable emission. In some embodiments, the change in the detectable emission is measured with a comparison to the orthodontic appliance at rest. In some embodiments, the change in the detectable emission is measured with a comparison to a non-strained portion of the orthodontic appliance, wherein non-strained portion comprises less than 10% volume of material that was enacted upon by the mechanical force. In some embodiments, the change in the detectable emission comprises a comparison with a detectable emission of the non-strained portion. In some embodiments, the detecting takes place while the orthodontic appliance is attached to a patient's teeth. In some embodiments, the detecting takes place in a kit as disclosed herein. In some embodiments, the measuring comprises a relative measurement of internal stress. In some embodiments, the measuring comprises an actual measurement of internal stress. In some embodiments, the method further comprises receiving an indication the orthodontic appliance should be replaced. In some embodiments, the indication the orthodontic appliance should be replaced is associated with the emission from the force probe. In some embodiments, the orthodontic appliance is one of a plurality of orthodontic appliances, and receiving the indication the orthodontic appliance should be replaced triggers instructing a user to use another one of the plurality of orthodontic appliances. In some embodiments, the method further comprising determining a stress value of the orthodontic appliance. In some embodiments, determining the stress value can confirm an attachment bonding to a patient's teeth. In some embodiments, determining the stress value can confirm a quality of the orthodontic appliance. In some embodiments, determining the stress value can provide a relative stress measurement.

In some aspects the present disclosure provides a method of producing a 3D printed orthodontic appliance, the method comprising direct fabrication of the orthodontic appliance, and optionally wherein the direct fabrication comprises cross-linking a resin as disclosed herein. In some embodiments, the 3D printed orthodontic appliance is an orthodontic appliance as disclosed herein. In some embodiments, the orthodontic appliance is one of a plurality of orthodontic appliances having a sequential order. In some embodiments, the method further comprises detecting an emission from the at least one force probe, and instructing a user to apply to the patient's teeth the next orthodontic appliance from the sequence. In some embodiments, the user and the patient are the same. In some embodiments, the user is instructed to apply the next orthodontic appliance from the sequence to the patient's teeth less than 14 days, less than 13 days, less than 12 days, less than 11 days, less than 10 days, less than 9 days, less than 8 days, less than 7 days, less than 6 days, less than 5 days, or less than 4 days after applying the previous orthodontic appliance.

In some aspects the present disclosure provides a method of detecting stress on an orthodontic appliance, the method comprising: applying an orthodontic appliance comprising a force probe to a patient's teeth; and detecting a level of emission from the force probe, wherein the emission from the force probe corresponds with a mechanical force. In some embodiments, the mechanical force comprises a force to move the patient's teeth. In some embodiments, the method comprises moving the patient's teeth from an initial position toward a final position. In some embodiments, the method further comprising instructing, based on the level of emission, the continued application of the orthodontic appliance to the patient's teeth. In some embodiments, instructing the continued application of the orthodontic appliance to the patient's teeth includes measuring the level of emission at or above a threshold value. In some embodiments, the method further comprises instructing, based on the level of emission, the application of a next orthodontic appliance from a sequence of orthodontic appliances to the patient's teeth. In some embodiments, instructing the application of the next orthodontic appliance to the patient's teeth includes measuring the level of emission below a threshold value. In some embodiments, the orthodontic appliance, when comprising mechanical force sufficient to move at least one of the patient's teeth has the level of emission at or above a threshold value, and when comprising a mechanical force that is not sufficient to move at least one of the patient's teeth has the level of emission below the threshold value. In some embodiments, the method further comprising instructing a user to remove the orthodontic appliance from the patient's teeth when the level of emission is below the threshold value, and to apply a next orthodontic appliance from a sequence of orthodontic appliances to the patient's teeth. In some embodiments, the user is instructed to apply the next orthodontic appliance from the sequence of orthodontic appliances to the patient's teeth less than 14 days, less than 13 days, less than 12 days, less than 11 days, less than 10 days, less than 9 days, less than 8 days, less than 7 days, less than 6 days, less than 5 days, or less than 4 days after applying the previous orthodontic appliance. In some embodiments, a user is instructed to apply a next orthodontic appliance from a sequence of orthodontic appliances at a time earlier than corresponding conventional orthodontic appliances.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A illustrates a tooth repositioning appliance, in accordance with embodiments.

FIG. 1B illustrates a tooth repositioning system, in accordance with embodiments.

FIG. 1C illustrates a method of orthodontic treatment using a plurality of appliances, in accordance with embodiments.

FIG. 2 illustrates a method for designing an orthodontic appliance, in accordance with embodiments.

FIG. 3 illustrates a method for digitally planning an orthodontic treatment, in accordance with embodiments.

FIG. 4 shows generating and administering treatment according to an embodiment of the present invention.

### DETAILED DESCRIPTION OF THE INVENTION

This disclosure provides methods, systems, devices, and kits for creating force probe incorporated materials and devices. In certain embodiments, the present disclosure provides an orthodontic appliance comprising a force probe. In certain aspects, the disclosure includes methods and processes to three-dimensionally print the force probe incorporated devices (e.g., orthodontic appliances) with favorable optical properties such as emission. These optical properties are advantageous in evaluating the amount of force or stress is applied to the device and determining the use or longevity of the device. These properties are of particular utility for patients on a treatment plan, using a plurality of treatment steps each step with a specific aligner, and determining whether the next stage of treatment is available based on the emission spectrum of the current treatment step aligner. Additionally, the force probe incorporated materials are useful in determining the longevity or defects of a materials other than aligners, for example a force probe incorporated polymeric material, of an object made therefrom. In some aspects, the devices or objects are three-dimensionally printed using the force probe incorporated polymeric materials.

In some aspects, the present disclosure relates to methods, systems, devices, and kits for detecting an emission from a material or device. In some embodiments, an orthodontic appliance has a first emission wavelength and a second emission wavelength. The measurement of the emission wavelength provides an indication of the force or stress applied to the orthodontic appliance. For particular utility, the detection of the emission wavelength of an orthodontic appliance is useful for determining whether a patient is ready for a next orthodontic appliance in a series of orthodontic appliance in a patient's treatment plan.

### Force Probes

### Förster-Based Probes

The present disclosure provides force probes that emit a wavelength based on the proximity between a fluorophore and a photon absorber which are coupled together by a linker. The distance between the fluorophore and photon absorber are affected by an external force which can alter the distance between the two components. For example, when a compression force is applied, the linker is compressed and the distance between the fluorophore and photon absorber are shortened. By contrast, when an expansion force is applied, the linker is expanded and the distance between the fluorophore and the photon absorber are lengthened. Based on the distance between the fluorophore and the photon absorber the resulting emission of light can either come from the photon absorber or the fluorophore after a suitable absorption wavelength is applied to the force probe. The suitable absorption wavelength can be an artificial light or a natural light. Methods of measuring the emission wavelength and application of particular absorption wavelengths can be easily determined using routine procedures by a person skilled in the art. Methods of detecting the emission wavelength and application of particular absorption wavelengths can be easily determined using routine procedures by a person skilled in the art. In some embodiments, the force probe is luminescent. In some embodiments, the force probe is fluorescent or phosphorescent. In some embodiments, the force probe comprises a fluorophore, a photon absorber, and a linker. In some embodiments, the fluorophore is coupled to the photon absorber. In some embodiments, the linker is a flexible tether. In some embodiments, fluorophore is coupled to the photon absorber via the flexible tether.

In some embodiments, the force probe has an unstrained configuration. In some embodiments, the force probe, when in an unstrained configuration, has a first emission spectrum. In some embodiments, the force probe has a strained configuration. In some embodiments, the force probe, when in the strained configuration, has a second emission spectrum. In some embodiments, the unstrained configuration has an unstrained maximum emission wavelength. In some embodiments, the strained configuration has a strained maximum emission wavelength. In preferred embodiments, the first emission spectrum and the second emission spectrum are distinct from one another. In some embodiments, the application of an external force causes a transition between the first spectrum and the second spectrum. In some embodiments, transition between the first emission spectrum and the second emission spectrum occurs when an external force is applied to the force probe. In some embodiments, transition between the first emission spectrum and the second emission spectrum occurs when a mechanical force is applied to the force probe. In certain embodiments, a transition between the unstrained configuration and the strained configuration occurs when force is applied to the material into which the force probe is incorporated. In some embodiments, the transition between the unstrained configuration and the strained configuration of the force probe occurs when force is applied to the object into which the force probe is incorporated. In some embodiments, the transition between the unstrained configuration and the strained configuration occurs when a force is applied to the orthodontic appliance into which the force probe is incorporated. In some embodiments, the force comprises a mechanical force, comprising application of the orthodontic appliance to a patient's teeth.

In some embodiments, the transition between the first detectable emission and the second detectable emission comprises a change in a maximum emission wavelength. In some embodiments, the change in the maximum emission wavelength is at least 400 nm, at least 300 nm, at least 200 nm, at least 100 nm, at least 90 nm, at least 80 nm, at least 70 nm, at least 60 nm, at least 50 nm, at least 40 nm, at least 30 nm, at least 20 nm, or at least 10 nm. In some embodiments, the change in the maximum emission wavelength is at most 400 nm, at most 300 nm, at most 200 nm, at most 100 nm, at most 90 nm, at most 80 nm, at most 70 nm, at most 60 nm, at most 50 nm, at most 40 nm, at most 30 nm, at most 20 nm, or at most 10 nm. In some embodiments, the change in the maximum emission wavelength is at least 20 nm.

In some embodiments, maximum emission wavelength is between 200 nm to 800 nm, 200 nm to 700 nm, 200 nm to 600 nm, 200 nm to 500 nm, 200 nm to 400 nm, or 200 nm to 300 nm. In some embodiments, the maximum emission wavelength is between 300 nm to 800 nm, 400 nm to 800 nm, 500 nm to 800 nm, 600 nm to 800 nm, or 700 nm to 800 nm. In some embodiments, the maximum emission corresponds to the force applied to the force probe. In some embodiments, the maximum emission corresponds linearly with the force applied to the force probe.

In some embodiments, the force applied to change the maximum wavelength is greater than 1 pN, greater than 2 pN, greater than 3 pN, greater than 4 pN, greater than 5 pN, greater than 6 pN, greater than 7 pN, greater than 8 pN, greater than 9 pN, greater than 10 pN, greater than 25 pN, greater than 50 pN, greater than 100 pN, greater than 200 pN, greater than 300 pN, greater than 400 pN, greater than 500 pN, greater than 1000 pN, greater than 1500 pN, or greater than 2000 pN In some embodiments, the force applied to change the maximum wavelength is less than 1500 pN, less than 1000 pN, less than 500 pN, less than 400 pN, less than 200 pN, less than 100 pN, or less than 50 pN.

In some embodiments, the force probe comprises a detectable fluorophore that has an emission spectrum. In some embodiments, the detectable fluorophore has a first detectable emission responsive to a first contact force and a second detectable emission responsive to a second contact force. In some embodiments, the transition between the first detectable emission and the second detectable emission occurs when an external force is applied to the force probe. In some embodiments, the transition between the first detectable emission and the second detectable emission occurs when a mechanical force is applied to the force probe. In some embodiments, the detectable fluorophore comprises a xanthene derivative, a cyanine derivative, a squaraine derivative, a naphthalene derivative, a coumarin derivative, an oxadiazole derivative, an anthracene derivative, a pyrene derivative, an oxazine derivative, an acridine derivative, an arylmethine derivative, a tetrapyrrole derivative, or a combination thereof.

In some embodiments, the photon absorber of the force probe is a quencher. In preferred embodiments, the detectable fluorophore has an emission spectrum that overlaps with an absorption spectrum of the quencher. In some embodiments, at least 10%, at least 20%, at least 30%, at least 40%, at least 50%, at least 55%, at least 60%, at least 65%, at least 70%, at least 75%, at least 80%, at least 85%, at least 90%, at least 95%, at least 96%, at least 97%, at least 98%, or at least 99% of an area of the absorption spectrum of the quencher overlaps with the emission spectrum of the detectable fluorophore. In some embodiments, at least 50% of an area of the absorption spectrum of the quencher overlaps with the emission spectrum of the detectable fluorophore. In some embodiments, at least 10% of an area of the absorption spectrum of the quencher overlaps with the emission spectrum of the detectable fluorophore. In some embodiments, the quencher comprises 4-(dimethylaminoazo)benzene-4-carboxylic acid, a DDQ quencher, a BHQ quencher, a QSY quencher, a derivative thereof, or a combination thereof.

In some embodiments, the photon absorber of the force probe is a second fluorophore. In preferred embodiments, the detectable fluorophore has an emission spectrum that overlaps with an absorption spectrum of the second fluorophore. In some embodiments, at least 10%, at least 20%, at least 30%, at least 40%, at least 50%, at least 55%, at least 60%, at least 65%, at least 70%, at least 75%, at least 80%, at least 85%, at least 90%, at least 95%, at least 96%, at least 97%, at least 98%, or at least 99% of an area of the absorption spectrum of the second fluorophore overlaps with the emission spectrum of the detectable fluorophore. In some embodiments, at least 50% of an area of the absorption spectrum of the second fluorophore overlaps with the emission spectrum of the detectable fluorophore. In some embodiments, at least 10% of an area of the absorption spectrum of the second fluorophore overlaps with the emission spectrum of the detectable fluorophore. In some embodiments, the second fluorophore comprises a xanthene derivative, a cyanine derivative, a squaraine derivative, a naphthalene derivative, a coumarin derivative, an oxadiazole derivative, an anthracene derivative, a pyrene derivative, an oxazine derivative, an acridine derivative, an arylmethine derivative, a tetrapyrrole derivative, or a combination thereof.

In some embodiments, the photon absorber is coupled to the detectable fluorophore. In some embodiments, the force probe comprises a flexible tether, and wherein the photon absorber and the detectable fluorophore are each coupled to the flexible tether. Various types of tethers are known and demonstrated in C. Jurchenko et al., Mol Cell Biol., 2015, 35 (15), pp 2570-2582 and C. Yang et al., Biochimica et Biophysica Acta, 2015, 1853, pp 1889-1904, the disclosures of each of which are incorporated herein by reference in their entirety. In some embodiments, the flexible tether comprises a polymer chain or a peptide chain. In some embodiments, the flexible tether is a polymer chain. In some embodiments, the flexible tether is a peptide chain. In some embodiments, the flexible tether is ethylene glycol. In some embodiments, the ethylene glycol linker is represented by [—(CH₂CH₂—O)—]ₙ. In some embodiments n is represented by 1, 2, 3, 4, 5, 6, 7, 8, 9, 10, 20, 50, 100, or 200. In some embodiments, n is at least 1, at least 5, at least 10, at least 20, at least 50, at least 100, at least 200. In some embodiments, n is at most 1, at most 5, at most 10, at most 20, at most 50, at most 100, at most 200. In some embodiments, the polymer chain comprises repeating ethylene glycol units. In some embodiments, the repeating unit comprises at least 1, at least 5, at least 10, at least 20, at least 50, at least 100, at least 200 ethylene glycol units. In some embodiments, the ethylene glycol linker is functionalized on at least one end of the linker. In some embodiments, the ethylene glycol linker is functionalized by an amide or thiol group. In some embodiments, the ethylene glycol linker is functionalized on both ends by an amide group. In some embodiments, the ethylene glycol linker is functionalized on both ends by a thiol group.

In some embodiments, the detectable fluorophore and the photon absorber are separated by a distance of at most 10 nm when at unstrained. In some embodiments, the detectable fluorophore and the photon absorber are separated by a distance of at most 100 nm, at most 50 nm, at most 25 nm, at most 20 nm, at most 15 nm, at most 10 nm, at most 10 nm, at most 9 nm, at most 8 nm, at most 7 nm, at most 6 nm, or at most 5 nm when unstrained. In some embodiments, the detectable fluorophore and the photon absorber are separated by a distance of at least 25 nm, at least 20 nm, at least 15 nm, at least 10 nm, at least 10 nm, at least 9 nm, at least 8 nm, at least 7 nm, at least 6 nm, or at least 5 nm when unstrained.

In some embodiments, the photon absorber and the detectable fluorophore has a Förster distance. In some embodiments, the distance between the detectable fluorophore and the photon absorber in the force probe at rest is 0.1-fold, 0.2-fold, 0.3-fold, 0.4-fold, 0.5-fold, 0.6-fold, 0.7-fold, 0.8-fold, 0.9-fold, 1.0 fold, 1.1-fold, 1.2-fold, 1.3-fold, 1.4-fold, 1.5-fold, 1.6-fold, 1.7-fold, 1.8-fold, 1.9-fold, 2-fold, 3-fold, 4-fold, 5-fold, 6-fold, 7-fold, 8-fold, 9-fold, 10-fold, 20-fold, 30-fold, 40-fold, 50-fold, and 100-fold the Förster distance.

In some embodiments, the distance between the detectable fluorophore and the photon absorber in the force probe at rest is at most 0.1-fold, at most 0.2-fold, at most 0.3-fold, at most 0.4-fold, at most 0.5-fold, at most 0.6-fold, at most 0.7-fold, at most 0.8-fold, at most 0.9-fold, at most 1.0 fold, at most 1.1-fold, at most 1.2-fold, at most 1.3-fold, at most 1.4-fold, at most 1.5-fold, at most 1.6-fold, at most 1.7-fold, at most 1.8-fold, at most 1.9-fold, at most 2-fold, at most 3-fold, at most 4-fold, at most 5-fold, at most 6-fold, at most 7-fold, at most 8-fold, at most 9-fold, at most 10-fold, at most 20-fold, at most 30-fold, at most 40-fold, at most 50-fold, and at most 100-fold the Förster distance. In some embodiments, the distance between the detectable fluorophore and the photon absorber in the force probe at rest is at most 1.5-fold the Förster distance. In some embodiments, the distance between the detectable fluorophore and the photon absorber in the force probe at rest is at most 1.5-fold the Förster distance when a mechanical force is applied.

In some embodiments, the distance between the detectable fluorophore and the photon absorber in the force probe at rest is at least 0.1-fold, at least 0.2-fold, at least 0.3-fold, at least 0.4-fold, at least 0.5-fold, at least 0.6-fold, at least 0.7-fold, at least 0.8-fold, at least 0.9-fold, at least 1.0 fold, at least 1.1-fold, at least 1.2-fold, at least 1.3-fold, at least 1.4-fold, at least 1.5-fold, at least 1.6-fold, at least 1.7-fold, at least 1.8-fold, at least 1.9-fold, at least 2-fold, at least 3-fold, at least 4-fold, at least 5-fold, at least 6-fold, at least 7-fold, at least 8-fold, at least 9-fold, at least 10-fold, at least 20-fold, at least 30-fold, at least 40-fold, at least 50-fold, and at least 100-fold the Förster distance. In some embodiments, the distance between the detectable fluorophore and the photon absorber is at least 0.5-fold the Förster distance when a mechanical force is applied.

In some embodiments, the detectable fluorophore and the photon absorber in the force probe have a photon transfer efficiency. In some embodiments, the photon transfer efficiency between the detectable fluorophore and the photon absorber is at least 10%, at least 20%, at least 30%, at least 40%, at least 50%, at least 55%, at least 60%, at least 65%, at least 70%, at least 75%, at least 80%, at least 85%, at least 90%, at least 95%, at least 96%, at least 97%, at least 98%, or at least 99%. In some embodiments, the photon transfer efficiency between the detectable fluorophore and the photon absorber is at most 10%, at most 20%, at most 30%, at most 40%, at most 50%, at most 55%, at most 60%, at most 65%, at most 70%, at most 75%, at most 80%, at most 85%, at most 90%, at most 95%, at most 96%, at most 97%, at most 98%, or at most 99%. In some embodiments, the force probe is a förster-based probe.

### Mechanophores

The present disclosure provides force probes that are sensitive to stressing force, i.e. mechanophores. Mechanophores, can have an observable color change when a stressing force is applied. Mechanophores, can have an observable emission spectrum when a stressing force is applied. In some cases, the observable color change can aid in the colorimetric determination of mechanophores that are stressed. In some embodiments, the force probe is luminescent. In some embodiments, the force probe is fluorescent or phosphorescent. In some cases, the mechanophore is a dye. In some cases, the mechanophore is a functional dye. In some cases, the mechanophore is a single molecule. In some cases, the dye or functional dye is a single molecule. In some embodiments, the force probe is a mechanophore. In some cases, the force probe is a single molecule. In some cases, the single molecule is selected from the group consisting of a spiropyran, an aromatic disulfide, a nitroxyl, a stilbene, and a dye. The single molecule mechanophore can be further functionalized and whose synthetic manipulations can be easily synthesized by someone skilled in the art.

In some embodiments, the mechanophore changes color based on a conformational change of the single molecule. In some embodiments, the conformational change occurs on the application of an external force. In some embodiments, the external force is a stressing force. In some embodiments, the color change occurs on application of an external force. In some embodiments, the conformational change of the single molecule is a ring opening or an E/Z-isomerization. In some embodiments, the conformational change occurs in at least one part of the molecule, for example the E/Z-isomerization occurs at one double bond but not at another within the molecule. Dissociation within the single molecule can also cause the mechanophore to change color. In some embodiments, the dissociation is caused by shear flows. A single molecule with a readily liable moiety would classify as dissociation. By way of a non-limiting illustration, the dissociation of a weak ligand, an olefin, or a carbene would classify as a liable moiety. In some embodiments, the color change corresponds to an emission wavelength.

In some embodiments, the ring opening of the single molecule causes an observe color change. In some embodiments, the ring opening of the single molecule causes an emission of light at a particular wavelength. In some embodiments, the dissociation of the single molecule can cause a color change. In some embodiments, the mechanophore has a first wavelength when unstrained and a second wavelength when strained. In some embodiments, the mechanophore has a first wavelength when unstrained and a second wavelength when strained, the first wavelength and second wavelength are distinct from one another. In some embodiments, the mechanophore has a first emission wavelength when unstrained and a second emission wavelength when strained. In some embodiments, the mechanophore has a first emission wavelength when unstrained and a second emission wavelength when strained, the first emission wavelength and second emission wavelength are distinct from one another.

In some embodiments, the transition between the first emission wavelength and the second emission wavelength comprises a change in the maximum emission wavelength. In some embodiments, the change in the maximum emission wavelength is at least 400 nm, at least 300 nm, at least 200 nm, at least 100 nm, at least 90 nm, at least 80 nm, at least 70 nm, at least 60 nm, at least 50 nm, at least 40 nm, at least 30 nm, at least 20 nm, or at least 10 nm. In some embodiments, the change in the maximum emission wavelength is at most 400 nm, at most 300 nm, at most 200 nm, at most 100 nm, at most 90 nm, at most 80 nm, at most 70 nm, at most 60 nm, at most 50 nm, at most 40 nm, at most 30 nm, at most 20 nm, or at most 10 nm. In some embodiments, the change in the maximum emission wavelength is at least 20 nm.

In some embodiments, the maximum emission wavelength is between 200 nm to 800 nm, 200 nm to 700 nm, 200 nm to 600 nm, 200 nm to 500 nm, 200 nm to 400 nm, or 200 nm to 300 nm. In some embodiments, the maximum emission wavelength is between 300 nm to 800 nm, 400 nm to 800 nm, 500 nm to 800 nm, 600 nm to 800 nm, or 700 nm to 800 nm. In some embodiments, the maximum emission corresponds with the force applied to the mechanophore. In some embodiments, the maximum emission corresponds linearly with the force applied to the mechanophore.

In some embodiments, a force is applied to change the maximum wavelength of the mechanophore. In some embodiments, the force applied to change the maximum wavelength is greater than 1 pN, greater than 2 pN, greater than 3 pN, greater than 4 pN, greater than 5 pN, greater than 6 pN, greater than 7 pN, greater than 8 pN, greater than 9 pN, greater than 10 pN, greater than 25 pN, greater than 50 pN, greater than 100 pN, greater than 200 pN, greater than 300 pN, greater than 400 pN, greater than 500 pN, greater than 1000 pN, greater than 1500 pN, or greater than 2000 pN when applied to the mechanophore. In some embodiments, the force applied to change the maximum wavelength is less than 2000 pN, less than 1500 pN, less than 1000 pN, less than 500 pN, less than 400 pN, less than 200 pN, less than 100 pN, or less than 50 pN when applied to the mechanophore.

In some embodiments, the mechanophore further comprises a linker within the single molecule. For example, a stilbene that comprises a linker from a first end of the molecule to a second end of the molecule. Examples of such are provided in G. Gossweiler et al., J. Am. Chem. Soc., 2015, 137 (19), pp 6148-6151 and Z. Huang et al., 2010, Pure Appl. Chem., 82 (4), pp 931-951, the disclosures of each of which are incorporated herein by reference in their entirety. The linker can provide specific E/Z isomerization of the molecule, as when the linker is in an unstrained state the molecule is in a first isomerization conformation, and when linker is in strained state the molecule is in a second isomerization conformation. In some embodiments, the strained state provides a strained state emission wavelength that is difference than the unstrained state that provides an unstrained state emission wavelength.

In some embodiments, the linker is a peptide chain. In some embodiments, the linker is ethylene glycol. In some embodiments, the ethylene glycol linker is represented by (—(CH₂CH₂—O)—)ₙ. In some embodiments n is represented by 1, 2, 3, 4, 5, 6, 7, 8, 9, 10, 20, 50, 100, or 200. In some embodiments, n is at least 1, at least 5, at least 10, at least 20, at least 50, at least 100, at least 200. In some embodiments, n is at most 1, at most 5, at most 10, at most 20, at most 50, at most 100, at most 200. In some embodiments, the polymer chain comprises repeating ethylene glycol units. In some embodiments, the repeating unit comprises at least 1, at least 5, at least 10, at least 20, at least 50, at least 100, at least 200 ethylene glycol units. In some embodiments, the ethylene glycol linker is functionalized on at least one end of the linker. In some embodiments, the ethylene glycol linker is functionalized with by an amide or thiol group. In some embodiments, the ethylene glycol linker is functionalized on both ends by an amide group. In some embodiments, the force probe is mechanophore.

### Resins Incorporating Force Probes

The present disclosure provides a resin which incorporates at least one force probe as described herein, for example an förster-based probe or a mechanophore. The force probe incorporated resin comprises an oligomer and a photoinitiator. In some embodiments, a resin comprises an oligomer, a force probe and a photoinitiator. In some embodiments, the force probe is a probe as disclosed herein. In some embodiments, the resin comprises a force probe as disclosed herein, an oligomer, and a photoinitiator. In some embodiments, the resin comprises an emission based probe, an oligomer, and a photoinitiator. In some embodiments, the resin comprises a mechanophore, an oligomer, and a photoinitiator. In some embodiments, the force probe incorporated resin comprises 0.01-10 wt %, 0.01-5 wt %, 0.01-4 wt %, 0.01-3 wt %, 0.01-2 wt %, or 0.01-1 wt % of the force probes. In some embodiments, the resin comprises 0.01-2 wt % of the force probes. In some embodiments, the resin comprises 0.01-10 wt %, 0.02-5 wt %, 0.05-4 wt %, 0.1-3 wt %, 0.1-2 wt %, or 0.1-1 wt % of the force probes. In some embodiments, the resin comprises 0.1-2 wt % of the force probes. In some embodiments, the resin comprises 0.01-5 wt % of the force probe.

In some embodiments, the resin comprises an oligomer having a number-average molecular weight of greater than or equal to 3,000 Da, greater than or equal to 4,000 Da, greater than or equal to 5,000 Da, greater than or equal to 6,000 Da, greater than or equal to 7,000 Da, greater than or equal to 8,000 Da, greater than or equal to 9,000 Da, or greater than or equal to 10,000 Da. In some embodiments, the resin comprises an oligomers having a number-average molecular weight of less than 30,000 Da, less than 25,000 Da, less than 20,000 Da, less than 15,000 Da, less than 10,000 Da, or less than 5,000 Da. In some embodiments the oligomer has a number-average molecular weight from 3,000 Da to 10,000 Da, from 3,000 Da to 9,000 Da, from 3,000 Da to 8,000 Da, or from 3,000 Da to 7,000 Da. In preferred embodiments, the resin comprises an oligomer having a number-average molecular weight of greater than 3,000 Da. In some preferred embodiments, the number-average molecular weight of the oligomer is from 9,000 Da to 20,000 Da.

In some embodiments, the force probe incorporated resin comprises an oligomer comprising a plurality of monomers. In certain embodiments, the average chain length of the oligomer is from 20 to 200 monomers. In some embodiments, the oligomer comprises a plurality of repeating units (e.g., repeating monomers). In some embodiments, the oligomer comprises a backbone that consists or consists essentially of repeating units. In some embodiments, the oligomer comprises from 20 to 200 repeating units.

In some embodiments, the oligomer comprises an aliphatic urethane acrylate, an aliphatic urethane methacrylate, or a combination thereof. In some embodiments, the oligomer comprises a hydrophobic urethane acrylate, a hydrophobic urethane methacrylate, or a combination thereof. In some embodiments, the oligomer comprises a polybutadiene urethane acrylate, a polybutadiene urethane methacrylate, or a combination thereof. In some embodiments, the oligomer comprises a polyether urethane acrylate, a polyether urethane methacrylate, or a combination thereof. In some embodiments, the oligomer comprises Dymax BRC-4421, Dymax BR-543, Dymax BR-543 MB, Exothane 108, Exothane 10, isophorone urethane dimethacrylate (IPDI-UDMA), CN991, CN9782, CN3211, CN9782, CN9009, PU3201NT, an acrylate thereof, a methacrylate thereof, or a combination thereof. In some embodiments, the oligomer is an aliphatic urethane diacrylate, an aliphatic urethane dimethacrylate, or a combination thereof.

In some embodiments, the oligomer comprises two or more functional groups. In some embodiments, the oligomer is difunctional. In some embodiments, the oligomer is monofunctional. In certain embodiments, the resin comprises a plurality of oligomers. In some embodiments, the plurality of oligomers comprise a monofunctional oligomer, a difunctional oligomer, a multifunctional oligomer, or a combination thereof. In certain embodiments, the oligomer is not functionalized with reactive groups. In some embodiments, the oligomer has a high number-average molecular weight and the oligomer is not functionalized with reactive groups. In some embodiments, the oligomer has a number-average molecular weight greater than 15 kDa and is not functionalized with a reactive group.

In some embodiments, the oligomer comprises at least one reactive functional group. In some embodiments, the reactive functional groups allow for further modification of the oligomer and/or formed polymer, such as additional polymerization. In some embodiments, the oligomer comprises 1, 2, 3, 4, 5, 6, 7, 8, 9, 10, or more than 10 reactive functional groups. The reactive functional groups can be the same, or they can be of different functionality. In some embodiments, the oligomer is a telechelic polymer (i.e., a polymer having di-end functionalization, wherein both ends have the same functionality). In some embodiments, the one or more functional groups are at the terminal end(s) of the oligomer. In some embodiments, the one or more reactive functional groups are located at positions other than the terminal end(s) of the oligomer (e.g., in-chain and/or pendant functional groups). In some embodiments, the oligomer comprises a plurality of reactive functional groups, and the reactive functional groups are located at one or both terminal ends of the oligomer, in-chain, at a pendant (e.g., a side group attached to the polymer backbone), or any combination thereof. In some embodiments, the plurality of reactive functional groups are the same. In other embodiments, the plurality of reactive functional groups are different from one another. In some embodiments, the plurality of reactive functional groups comprises at least two functional groups that are the same.

Non-limiting examples of reactive functional groups include free radically polymerizable functionalities, photoactive groups, groups facilitating step growth polymerization, thermally reactive groups, and/or groups that facilitate bond formation (e.g., covalent bond formation). In some embodiments, the functional groups comprise an acrylate, a methacrylate, an acrylamide, a vinyl group, a vinyl ether, a vinyl ester, a thiol, an allyl ether, a norbornene, a vinyl acetate, a maleate, a fumarate, a maleimide, an epoxide, a ring-strained cyclic ether, a ring-strained thioether, a cyclic ester, a cyclic carbonate, a cyclic silane, a cyclic siloxane, a hydroxyl, an amine, an isocyanate, a blocked isocyanate, an acid chloride, an activated ester, a Diels-Alder reactive group, a furan, a cyclopentadiene, an anhydride, a group favorable toward photodimerization (e.g., an anthracene, an acenaphthalene, or a coumarin), a group that photodegrades into a reactive species (e.g., Norrish Type 1 and 2 materials), an azide, a derivative thereof, or a combination thereof.

In some embodiments, the force probe incorporated resin comprises 0.5-99.5 wt % of the oligomer, 1-99 wt % of the oligomer, 10-95 wt % of the oligomer, 20-90 wt % of the oligomer, 25-60 wt % of the oligomer, or 35-50 wt % of the oligomer. In some embodiments, the resin comprises 25-60 wt % of the oligomer. In other embodiments, the resin comprises 99.5 wt % or less of the oligomer.

In some embodiments, the force probe incorporated resins have a low viscosity at ambient temperatures. In some embodiments, the resin has a viscosity less than or equal to 30,000 cP, less than or equal to 25,000 cP, less than or equal to 20,000 cP, less than or equal to 19,000 cP, less than or equal to 18,000 cP, less than or equal to 17,000 cP, less than or equal to 16,000 cP, less than or equal to 15,000 cP, less than or equal to 14,000 cP, less than or equal to 13,000 cP, less than or equal to 12,000 cP, less than or equal to 11,000 cP, less than or equal to 10,000 cP, less than or equal to 9,000 cP, less than or equal to 8,000 cP, less than or equal to 7,000 cP, less than or equal to 6,000 cP, or less than or equal to 5,000 cP at 25° C. The dynamic viscosity of a fluid indicates its resistance to shearing flows. The SI unit for dynamic viscosity is the Poiseuille (Pa·s). Dynamic viscosity is commonly given in units of centipoise, where 1 centipoise (cP) is equivalent to 1 mPa·s. Kinematic viscosity is the ratio of the dynamic viscosity to the density of the fluid; the SI unit is m²/s. Devices for measuring viscosity include viscometers and rheometers. The viscosity of a composition described herein may be measured at various temperatures using a rheometer. For example, a Discovery HR-2 rheometer from TA Instruments may be used for rheological measurement in rotation mode (40 mm parallel plate, 200 μm gap, 4 s⁻¹).

In some embodiments, the force probe incorporated resin has a viscosity less than or equal to 100,000 cP, less than or equal to 90,000 cP, less than or equal to 80,000 cP, less than or equal to 70,000 cP, less than or equal to 60,000 cP, less than or equal to 50,000 cP, less than or equal to 40,000 cP, less than or equal to 35,000 cP, less than or equal to 30,000 cP, less than or equal to 25,000 cP, less than or equal to 20,000 cP, less than or equal to 15,000 cP, less than or equal to 10,000 cP, less than or equal to 5,000 cP, less than or equal to 4,000 cP, less than or equal to 3,000 cP, less than or equal to 2,000 cP, less than or equal to 1,000 cP, less than or equal to 750 cP, less than or equal to 500 cP, less than or equal to 250 cP, less than or equal to 100 cP, less than or equal to 90 cP, less than or equal to 80 cP, less than or equal to 70 cP, less than or equal to 60 cP, less than or equal to 50 cP, less than or equal to 40 cP, less than or equal to 30 cP, less than or equal to 20 cP, or less than or equal to 10 cP at a printing temperature. In some embodiments, the resin has a viscosity from 50,000 cP to 30 cP, from 40,000 cP to 30 cP, from 30,000 cP to 30 cP, from 20,000 cP to 30 cP, from 10,000 cP to 30 cP, or from 5,000 cP to 30 cP at a printing temperature. In some embodiments, the printing temperature is from 0° C. to 25° C., from 25° C. to 40° C., from 40° C. to 100° C., or from 20° C. to 150° C.

In some embodiments, the force probe incorporated resin has a viscosity less than 20,000 cP at a print temperature. In some embodiments, the print temperature is from 10° C. to 200° C., from 15° C. to 175° C., from 20° C. to 150° C., from 25° C. to 125° C., or from 30° C. to 100° C. In some embodiments, the print temperature is from 20° C. to 150° C.

Photoinitiators may be useful for various purposes, including for curing of polymers, including those that can be activated with light and initiate polymerization of the polymerizable components of the formulation. In embodiments, the photoinitiator is a radical photoinitiator and/or a cationic initiator. In some embodiments, the photoinitiator is a Type I photoinitiator which undergoes a unimolecular bond cleavage to generate free radicals. In an additional embodiment the photoinitiator is a Type II photoinitiator which undergoes a bimolecular reaction to generate free radicals. Common Type I photoinitiators include, but are not limited to benzoin ethers, benzil ketals, α-dialkoxy-acetophenones, α-hydroxy-alkyl phenones and acyl-phosphine oxides. Common Type II photoinitiators include benzophenones/amines and thioxanthones/amines. Cationic initiators include aryldiazonium, diaryliodonium, and triarylsulfonium salts. In preferred embodiments, the photoinitiator comprises diphenyl (2,4,6-trimethylbenzoyl)-phosphine oxide, ethyl (2,4,6-trimethylbenzoyl) phenyl phosphinate, or a combination thereof.

In certain embodiments, the photoinitiator comprises a radical photoinitiator, a cationic initiator, and/or a photobase generator. In some embodiments, the photoinitiator is a Type I photoinitiator which undergoes a unimolecular bond cleavage to generate free radicals, or a Type II photoinitiator which undergoes a bimolecular reaction to generate free radicals. In some embodiments, the Type I photoinitiator is a benzoin ether, a benzil ketal, an α-dialkoxy-acetophenone, an α-hydroxy-alkyl phenome, or an acyl-phosphine oxide. In some embodiments, the Type II photoinitiator is a benzophenone/amine or a thioxanthone/amine. In some embodiments, the cationic initiators is an aryldiazonium, a diaryliodonium, or a triarylsulfonium salt.

In some embodiments, the photoinitiator initiates photopolymerization using light energy. In some embodiments, the photoinitiator initiates photopolymerization with exposure to light energy from 800 nm to 250 nm, from 800 nm to 350 nm, from 800 nm to 450 nm, from 800 nm to 550 nm, from 800 nm to 650 nm, from 600 nm to 250 nm, from 600 nm to 350 nm, from 600 nm to 450 nm, or from 400 nm to 250 nm. In some embodiments, the photoinitiator initiates photopolymerization following absorption of two photons, which can use longer wavelengths of light to initiate the photopolymerization.

In some embodiments, the force probe incorporated resin comprises 0.01-10 wt %, 0.02-5 wt %, 0.05-4 wt %, 0.1-3 wt %, 0.1-2 wt %, or 0.1-1 wt % of the initiator. In some embodiments, the resin comprises 0.1-2 wt % of the initiator. In some embodiments, the resin comprises 0.01-10 wt %, 0.02-5 wt %, 0.05-4 wt %, 0.1-3 wt %, 0.1-2 wt %, or 0.1-1 wt % of the photoinitiator. In some embodiments, the resin comprises 0.1-2 wt % of the photoinitiator.

Additional Resins Incorporating Force Probes

In some embodiments, the resin further comprises a reactive diluent, a crosslinking modifier, a light blocker, a thermal initiator, or any combination thereof. In some embodiments, the force probe incorporated resins further comprise a reactive diluent. A “reactive diluent” as used herein refers to a substance which reduces the viscosity of another substance, such as a monomer or a curable resin. A reactive diluent may become part of another substance, such as a polymer obtained by a polymerization process. In some embodiments, a reactive diluent is a curable monomer which, when mixed with a force probe incorporated resin, reduces the viscosity of the resultant formulation and is incorporated into the polymer that results from polymerization of the formulation. The reactive diluent typically has a low viscosity. One or more reactive diluents may be included in the composition to reduce the viscosity of the resin (e.g., to a viscosity less than the viscosity of the force probe incorporated resin in the absence of the reactive diluent). In some embodiments, the reactive diluent has a viscosity lower than the viscosity of the oligomer. In some embodiments, the reactive diluent may reduce the viscosity of the resin. The reactive diluent or reactive diluents may reduce the viscosity of the resin by at least 10%, at least 20%, at least 30%, at least 40%, at least 50%, at least 60%, at least 70%, at least 80%, or at least 90%.

In some embodiments, the reactive diluent or reactive diluents have a melting point lower than the processing temperatures disclosed herein. In some embodiments, the reactive diluent or reactive diluents have a melting point less than 120° C., less than 110° C., less than 100° C., less than 90° C., less than 80° C., less than 70° C., less than 60° C., less than 50° C., less than 40° C., or less than 30° C. In some embodiments, the force probe incorporated resin comprises 10-75 wt % of the reactive diluent, 15-60 wt % of the reactive diluent, 20-50 wt % of the reactive diluent, 25-45 wt % of the reactive diluent, or 30-40 wt % of the reactive diluent. In some embodiments, the resin comprises 30-70 wt % of the reactive diluent. In some embodiments, the resin further comprises a crosslinking modifier. In certain embodiments, the reactive diluent comprises a crosslinking modifier.

In some embodiments, the reactive diluent comprises an acrylate, a methacrylate, or a combination thereof. As used herein, a “(meth)acrylate” (and variations thereof) is an acrylate, a methacrylate, or a combination thereof. Similarly, terms such as “di(meth)acrylate) is a diacrylate, a dimethacrylate, or a combination thereof “(meth)acryloxy” is an acryloxy, a methacryloxy, or a combination thereof; “tri(meth)acrylate” is a triacrylate, a trimethacrylate, or a combination thereof. As a non-limiting example, hydrobenzoic acid ester (meth)acrylate is understood to be hydrobenzoic acid ester acrylate, hydrobenzoic acid ester methacrylate, or a combination thereof. In some embodiments, the reactive diluent comprises a (meth)acrylate, a di(meth)acrylate, a di(meth)acrylate of polyglycols, a hydrobenzoic acid ester (meth)acrylate, a cycloalkyl-2-, 3-, or 4-((meth)acryloxy)benzoate, isobornyl (meth)acrylate, trimethylolpropane tri(meth)acrylate, triethylene glycol di(meth)acrylate (e.g., TEGDMA), 1,12-dodecanediol di(meth)acrylate (e.g., D4MA), 3,3,5-trimethcyclohexyl 2-((meth)acryloxy) benzoate (e.g., HSMA), benzyl salicylate (meth)acrylate (e.g., BSMA), 3,3,5-Trimethylcyclohexyl (meth)acrylate, tripropylene glycol di(meth)acrylate, hexane-1,6-diol di(meth)acrylate, tricyclodecanedimethanol di(meth)acrylate, tricyclodecanedimethanol di(meth)acrylate, hydroxyethyl (meth)acrylate, benzyl (meth)acrylate, a (poly)vinyl monomer, a derivative thereof, or a combination thereof.

In some embodiments, the reactive diluent comprises an acrylate or methacrylate. In some embodiments, the reactive diluent comprises a (poly)glycol di(meth)acrylate, a triethylene glycol di(meth)acrylate, a tetraethylene glycol di(meth)acrylate, bisphenol A di(meth)acrylate, a hydrogenated form of bisphenol A di(meth)acrylate, a methacrylate- or acrylate-terminated polyester oligomer, 4,4′-isopropylidenedicyclohexanol di(meth)acrylate, a salicylic ester (meth)acrylate, or cycloalkyl salicylate (meth)acrylate. In certain embodiments, the reactive diluent comprises a (poly)vinyl monomer. In certain embodiments, the reactive diluent comprises vinyl acetate, styrene, or divinylbenzene.

In some embodiments, the reactive diluent comprises a functional group selected from polyurethane, acrylate, methacrylate, vinyl ester, epoxy, and combinations thereof. For example, the reactive diluent is an acrylate, epoxy or urethane based diluent. In some embodiments, the reactive diluent is a vinyl monomer or a thiol monomer. As examples, the reactive diluent is selected from the group consisting of diacrylate monomers, triacrylate monomers, acyclic diacrylate monomers, cyclic diacrylate monomers, methacrylate monomers, vinyl ester monomers, polyurethane monomers with acrylate end groups and polyurethane monomers with epoxy end groups. In some embodiments, the reactive diluent is selected from the group consisting of 1-vinyl-2-pyrrolidinone (NVP), CEA (β-carboxyethylacrylate), trimethyl cyclohexyl acrylate (M1130), isobornyl acrylate (IBOA), Isobornyl methacrylate (IBOMA), tetrahydrofurfuryl methacrylate (M151), PETMP, TATATO, and any combination thereof. In some embodiments, the viscosity of the reactive diluent is less than the viscosity of other oligomer components in the formulation. In some embodiments, the viscosity of the reactive diluent is less than the viscosity of the crosslinking modifier.

In some embodiments, the force probe incorporated resin further comprises a crosslinking modifier. A “crosslinking modifier” as used herein refers to a substance which bonds one oligomer or polymer chain to another oligomer or polymer chain, thereby forming a crosslink. A crosslinking modifier may become part of another substance, such as a crosslink in a polymer material obtained by a polymerization process. In some embodiments, a crosslinking modifier is a curable unit which, when mixed with the resin, is incorporated as a crosslinker into the polymeric material that results from polymerization of the formulation. In certain embodiments, the resin comprises 0-25 wt % of the crosslinking modifier, the crosslinking modifier having a number-average molecular weight equal to or less than 3,000 Da, equal to or less than 2,500 Da, equal to or less than 2,000 Da, equal to or less than 1,500 Da, equal to or less than 1,250 Da, equal to or less than 1,000 Da, equal to or less than 800 Da, equal to or less than 600 Da, or equal to or less than 400 Da. In some embodiments, the crosslinking modifier can have a high glass transition temperature (Tg), which leads to a high heat deflection temperature. In some embodiments, the crosslinking modifier has a glass transition temperature greater than −10° C., greater than −5° C., greater than 0° C., greater than 5° C., greater than 10° C., greater than 15° C., greater than 20° C., or greater than 25° C. In some embodiments, the resin comprises 0-25 wt % of the crosslinking modifier, the crosslinking modifier having a number-average molecular weight equal to or less than 1,500 Da. In some embodiments, the crosslinking modifier comprises a (meth)acrylate-terminated polyester, a tricyclodecanediol di(meth)acrylate, a vinyl ester-terminated polyester, a tricyclodecanediol vinyl ester, a derivative thereof, or a combination thereof.

In some embodiments, the resin comprises more than one initiator (e.g., 2, 3, 4, 5, or more than 5 initiators). In some embodiments, the resin comprises an initiator that is a thermal initiator. In some embodiments, the thermal initiator comprises an azo compound, an inorganic peroxide, an organic peroxide, or any combination thereof. In certain embodiments, the thermal initiator comprises an organic peroxide. In some embodiments, the thermal initiator is selected from the group consisting of tert-amyl peroxybenzoate, 4,4-azobis(4-cyanovaleric acid), 1,1′-azobis(cyclohexanecarbonitrile), 2,2′-azobisisobutyronitrile (AIBN), benzoyl peroxide, 2,2-bis(tert-butylperoxy)butane, 1,1-bis(tert-butylperoxy)cyclohexane, 2,5-bis(tert-butylperoxy 2,5-dimethylhexane, 2,5-bis(tert-butylperoxy)-2,5-dimethyl-3-hexyne, bis(1-(tert-butylperoxy)-3,3,5-trimethylcyclohexane, tert-butyl hydroxyperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 2,4-pentanedione peroxide, peracetic acid, potassium persulfate, a derivative thereof, and a combination thereof. In preferred embodiments, the thermal initiator comprises azobisisobutyronitrile, 2,2′-azodi(2-methylbutyronitrile), or a combination thereof.

In some aspects, the force probe incorporated resin comprises from 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt % of the thermal initiator. In some aspects, the resin comprises from 0 to 0.5 wt % of the thermal initiator.

In some embodiments, the force probe incorporated resin comprises a light blocker in order to dissipate UV radiation. In some embodiments, the light blocker absorbs a specific UV energy value and/or range. In some embodiments, the light blocker is a UV light absorber, a pigment, a color concentrate, or an IR light absorber. In some embodiments, the light blocker comprises a benzotriazole (e.g., 2-(2′-hydroxy-phenyl benzotriazole), 2,2′-dihydroxy-4-methoxybenzophenone, 9,10-diethoxyanthracene, a hydroxyphenyltriazine, an oxanilide, a benzophenone, or a combination thereof. In some embodiments, the resin comprises from 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt % of the light blocker. In some embodiments, the resin comprises from 0 to 0.5 wt % of the light blocker.

In some embodiments, the additional components (e.g., a reactive diluent, a crosslinking modifier, a light blocker, or a thermal initiator) are functionalized to facilitate the incorporated into the polymer network. Thus, the functionalization of the components make it so that the components cannot readily be extracted from the final cured material. In certain embodiments, the reactive diluent, the crosslinking modifier, the light blocker, and/or the thermal initiator, are functionalized to facilitate their incorporation into the polymeric material. A polymer network, as used herein, can refer to a polymer composition comprising a plurality of polymer chains wherein a large portion (e.g., >80%) and optionally all the polymer chains are interconnected, for example via covalent crosslinking, to form a single polymer composition.

In some embodiments, the force probe incorporated resin disclosed herein are capable of being 3D printed (i.e., can be used in additive manufacturing).

### Polymeric Materials

The present disclosure provides polymeric materials formed from the force probe incorporated resins as disclosed herein. In some embodiments, the polymeric material is formed from the force probe incorporated resins disclosed herein with additive manufacturing. In some embodiments, the polymeric material is prepared by a process comprising: providing the force probe incorporated resin as described herein; and forming the polymeric material from the force probe incorporated resin with additive manufacturing. In some preferred embodiments, the polymeric material is prepared by a process comprising: providing a force probe incorporated resin comprising: a force probe, an oligomer, and a photoinitiator. In certain embodiments, the present disclosure provides polymeric materials formed from the methods and/or systems described herein. Polymeric materials disclosed herein have properties that are favorable for numerous applications and for the production of various devices. As a non-limiting example, the polymeric materials described herein are useful for production of orthodontic appliances, such as aligners. Orthodontic appliances require toughness and resilience to move a patient's teeth, while maintaining durability for use. In some embodiments, the polymeric material has a high glass transition temperature, a low creep, and a low stress relaxation.

Property values of the polymeric material can be determined, for example, by using the following methods:

stress relaxation properties can be assessed using an RSA-G2 instrument from TA Instruments, with a 3-point bending, according to ASTM D790; for example, stress relaxation can be measured at 30° C. and submerged in water, and reported as the remaining load after 24 hours, as either the percent (%) of initial load, and/or in MPa;

storage modulus can be measured at 37° C. and is reported in MPa;

T_{g} of the polymeric material can be assessed using dynamic mechanical analysis (DMA) and is provided herein as the tan δ peak;

tensile modulus, tensile strength, elongation at yield and elongation at break can be assessed according to ISO 527-2 5B;

tensile strength at yield, elongation at break, tensile strength, and Young's modulus can be assessed according to ASTM D1708 or ASTM D638; and

flexural stress remaining after 24 hours in wet environment at 37° C. (“flexural stress remaining”) can be assessed according to ASTM E328. Other methods can be used to characterize the materials described herein, and the above methods provide exemplary methods.

In some embodiments, the polymeric material is characterized by a tensile stress-strain curve that displays a yield point after which the test specimen continues to elongate, but there is no increase in load. Such yield point behavior can occur “near” the glass transition temperature, where the material is between the glassy and rubbery regimes and may be characterized as having viscoelastic behavior. In embodiments, viscoelastic behavior is observed in the temperature range 20° C. to 40° C. The yield stress is determined at the yield point. In some embodiments, the yield point follows an elastic region in which the slope of the stress-strain curve is constant or nearly constant. In embodiments, the modulus is determined from the initial slope of the stress-strain curve or as the secant modulus at 1% strain (e.g. when there is no linear portion of the stress-strain curve). The elongation at yield is determined from the strain at the yield point. When the yield point occurs at a maximum in the stress, the ultimate tensile strength is less than the yield strength. For a tensile test specimen, the strain is defined by ln (l/l₀), which may be approximated by (l−l₀)/l₀ at small strains (e.g. less than approximately 10%) and the elongation is l/l₀, where l is the gauge length after some deformation has occurred and l₀ is the initial gauge length. The mechanical properties can depend on the temperature at which they are measured. The test temperature may be below the expected use temperature for a dental appliance such as 35° C. to 40° C. In some embodiments, the test temperature is 23±2° C.

In some embodiments, the polymeric material has a hardness from 60 Shore A to 85 Shore D. In certain embodiments, the polymeric material has a hardness from 60-70 Shore A, from 70-80 Shore A, from 80-90 Shore A, from 90-100 Shore A, from 0-10 Shore D, from 10-20 Shore D, from 20-30 Shore D, from 30-40 Shore D, from 40-50 Shore D, from 50-60 Shore D, from 60-70 Shore D, from 70-80 Shore D, or from 80-85 Shore D.

In some embodiments, the polymeric material has an elongation at yield greater than 4%. In some embodiments, the polymeric material has an elongation at yield of 4% to 10%. In some aspects, the polymeric material is characterized by an elongation at yield of 5% to 15%.

In some embodiments, the polymeric material has an elongation at break value between 5% and 250%. In certain embodiments, the polymeric material has an elongation at break value between 10% and 250%, between 20% and 250%, between 30% and 250%, between 40% and 250%, between 50% and 250%, between 75% and 250%, between 100% and 250%, between 150% and 250%, between 200% and 250%, between 10% and 50%, between 50% and 100%, between 100% and 150%, between 150% and 200%, or between 20% and 250%. In preferred embodiments, the polymer material has an elongation at break greater than or equal to 5%. In certain embodiments, the polymer material has an elongation at break greater than 10%, an elongation at break greater than 20%, an elongation at break greater than 30%, an elongation at break of 5% to 250%, an elongation at break of 20% to 250%, or an elongation at break value between 40% and 250%.

In some embodiments, the polymeric material has a tensile modulus value greater than or equal to 100 MPa. In some embodiments, the polymeric material is characterized by a tensile modulus from 100 MPa to 2000 MPa or a tensile modulus from 800 MPa to 2000 MPa. In some embodiments, the polymeric material has a tensile modulus between 100 MPa and 5000 MPa. In certain embodiments, the polymeric material has a Young's modulus value between 500 MPa and 4000 MPa, between 700 MPa and 3000 MPa, between 1000 MPa and 2500 MPa, between 1200 MPa and 2400 MPa, between 1500 MPa and 2100 MPa, between 1700 MPa and 1900 MPa, between 100 MPa and 500 MPa, between 500 MPa and 1000 MPa, between 1000 MPa and 1500 MPa, between 1500 MPa and 2000 MPa, between 2000 MPa and 2500 MPa, between 2500 MPa and 3000 MPa, between 3000 MPa and 3500 MPa, between 3500 MPa and 4000 MPa, between 4000 MPa and 4500 MPa, or between 4500 MPa and 5000 MPa.

In some embodiments, the polymeric material has a storage modulus between 0.1 MPa and 4000 MPa. In preferred embodiments, the polymeric material has a storage modulus between 100 MPa and 2000 MPa. In even more preferred embodiments, the polymeric material has a storage modulus between 500 MPa and 1500 MPa. In additional preferred embodiments, the polymeric material has a storage modulus greater than or equal to 300 MPa. In certain embodiments, the polymeric material is characterized by a storage modulus of 0.1 MPa to 4000 MPa, a storage modulus of 300 MPa to 3000 MPa, or a storage modulus of 750 MPa to 3000 MPa. In some embodiments, the polymeric material has a storage modulus from 0.1 MPa to 3000 MPa, from 0.1 MPa to 2000 MPa, from 0.1 MPa to 1000 MPa, from 10 MPa to 4000 MPa, from 10 MPa to 3000 MPa, from 10 MPa to 2000 MPa, from 10 MPa to 1000 MPa, from 100 MPa to 4000 MPa, from 100 MPa to 3000 MPa, from 100 MPa to 2000 MPa, from 100 MPa to 1000 MPa, from 500 MPa to 4000 MPa, from 500 MPa to 3500 MPa, from 500 MPa to 3000 MPa, from 500 MPa to 2500 MPa, from 500 MPa to 2000 MPa, from 500 MPa to 1500 MPa, or from 500 MPa to 1000 MPa. The storage modulus can be measured at 37° C. and is reported in MPa.

In some embodiments, the polymeric material has a glass transition temperature (T_{g}) from 0° C. to 150° C. In preferred embodiments, the polymeric material has a glass transition temperature from 0° C. to 60° C. In some embodiments, the glass transition temperature is from 0° C. to 120° C., from 0° C. to 140° C., from 0° C. to 20° C., from 20° C. to 40° C., from 40° C. to 60° C., from 60° C. to 80° C., from 80° C. to 100° C., from 0° C. to 35° C., from 35° C. to 65° C., from 65° C. to 100° C., from 0° C. to 50° C., or from 50° C. to 100° C. In some embodiments, the polymeric material has a glass transition temperature from 0° C. to 10° C., from 10° C. to 20° C., from 20° C. to 30° C., from 30° C. to 40° C., from 40° C. to 50° C., from 50° C. to 60° C., from 60° C. to 70° C., from 70° C. to 80° C., or from 80° C. to 90° C. In some embodiments, the polymeric material has at least one glass transition temperature from −80° C. to 100° C., or preferably from −60° C. to 60° C. for applications near room temperature. In some embodiments, the polymeric material has more than one glass transition temperature. In certain embodiments, the polymeric material has more than one glass transition temperature, and an onset temperature for the lowest glass transition temperature is less than or equal to the use temperature. As a non-limiting example, a polymeric material with a use temperature of about 37° C. (i.e., the temperature of a human subject's mouth) can comprise at least two glass transition temperatures, and the onset temperature for the lowest of the glass transition temperatures is less than or equal to about 37° C.

In some embodiments, the polymeric material is clear, substantially clear, mostly clear, or opaque. In certain embodiments, the polymeric material is clear. In certain embodiments, the polymeric material is substantially clear. In certain embodiments, the polymeric material is mostly clear. In some embodiments, greater than 70% of visible light passes through the polymeric material. In certain embodiments, greater than 80% of visible light passes through the polymeric material. In certain embodiments, greater than 90% of visible light passes through the polymeric material. In certain embodiments, greater than 95% of visible light passes through the polymeric material. In certain embodiments, greater than 99% of visible light passes through the polymeric material. Transparency can be measured using a UV-Vis spectrophotometer. In some embodiments, the transparency is measured by measuring the passage of a wavelength of transparency. In some embodiments, greater than 70%, greater than 80%, greater than 90%, greater than 95%, or greater than 99% of the wavelength of transparency can pass through the polymeric material. In some embodiments, the wavelength of transparency is in the visible light range (i.e., from 400 nm to 800 nm), is in the infrared light range, or is in the ultraviolet light range. In some embodiments, the polymeric material does not have color. In other embodiments, the polymeric material appears white, off-white, or mostly transparent with white coloring, as detected by the human eye. In some embodiments, a color is added. In certain embodiments, the color is added with a dye, a pigment, or a combination thereof.

In some embodiments, greater than 20%, greater than 30%, greater than 40%, greater than 50%, greater than 60%, greater than 70%, greater than 80%, greater than 90%, or greater than 95% of visible light passes through the polymeric material after 24 hours in a wet environment at 37° C. In preferred embodiments, greater than 70% of visible light passes through the polymeric material after 24 hours in a wet environment at 37° C.

In some embodiments, the polymeric material has a stress relaxation measurement determined by ASTM D790 with 5% deflection on a 3-point bending test. In some embodiments, the stress relaxation can be measured by monitoring the time-dependent stress resulting from a steady strain. The extent of stress relaxation can also depend on the temperature, relative humidity and other applicable conditions (e.g., presence of water). In embodiments, the test conditions for stress relaxation are a temperature is 37±2° C. at 100% relative humidity or a temperature of 37±2° C. in water. Stress relaxation properties may be assessed using an RSA-G2 instrument from TA Instruments, with a 3-point bending, 2% strain method (or sometimes with a 5% strain method). The stress relaxation can be measured at 37° C. and 100% relative humidity and reported as the remaining load after 2 hours, as either the percent (%) of initial load or in MPa). In some embodiments, the polymeric material has a stress remaining of greater than or equal to 5% of the initial load. In some embodiments, the polymeric material is characterized by a stress remaining of 5% to 45% of the initial load. In certain aspects, the polymeric material is characterized by a stress remaining of 20% to 45% of the initial load. In certain embodiments, the polymeric material is characterized by a stress remaining of greater than or equal to 20% or greater than or equal to 35% of the initial load. In some embodiments, the stress relaxation measurement of the polymeric material has a stress remaining value at 24 hours in 30° C. water that is greater than 10% of the initial stress. In some embodiments, the stress relaxation measurement of the polymeric material has a stress remaining value at 24 hours in 30° C. water that is greater than 15%, greater than 20%, greater than 25%, greater than 30%, greater than 35%, greater than 40%, greater than 45%, or greater than 50% of the initial stress. In some embodiments, the polymeric material has a stress remaining greater than or equal to 0.01 MPa. In certain embodiments, the polymeric material is characterized by a stress remaining of 0.01 MPa to 15 MPa. In certain aspects, the polymeric material is characterized by a stress remaining of 2 MPa to 15 MPa.

In some embodiments, the polymeric material is characterized by a stress remaining of 5% to 85% of the initial load, such as 5% to 45%, 15% to 85%, or 20% to 45% of the initial load. In some embodiments, the polymeric material is characterized by a stress remaining of 0.01 MPa to 15 MPa, such as 2 MPa to 15 MPa. In some embodiments, the polymeric material is characterized by a stress remaining of greater than or equal to 20% of the initial load.

In some embodiments, the polymeric material is characterized by an emission wavelength. In some embodiments, the emission is measured using a fluorometer. In some embodiments the polymeric material is excited using artificial or natural light then the emission wavelength is measured. In some embodiments, the emission wavelength is between 200 nm to 800 nm, 200 nm to 700 nm, 200 nm to 600 nm, 200 nm to 500 nm, 200 nm to 400 nm, or 200 nm to 300 nm. In some embodiments, the emission wavelength is between 300 nm to 800 nm, 400 nm to 800 nm, 500 nm to 800 nm, 600 nm to 800 nm, or 700 nm to 800 nm. In some embodiments, the emission wavelength is the maximum emission wavelength. In some embodiments, the emission wavelength indicates either a strained conformation or an unstrained conformation of the force probe incorporated polymeric material.

Polymeric materials of the present invention can have a heat deflection temperature of greater than or equal to 20° C., greater than or equal to 40° C., greater than or equal to 80° C., or greater than or equal to 100° C. above of the use temperature. Heat deflection temperatures can be measured using, e.g., Heat Deflection Temperature ASTM D648, ISO 75. In some embodiments, the polymeric material is formed using 3D printing (i.e., by additive manufacturing) using photopolymerization. In some embodiments, the polymeric materials can be used in coatings, molds, injection molding machines, or other manufacturing methods that use or could use light during the curing process. In some embodiments, the polymeric material is well suited for applications that require, e.g., solvent resistance, humidity resistance, water resistance, creep resistance, or heat deflection resistance. In some embodiments, the polymeric material is biocompatible, bioinert, or a combination thereof.

### Methods of Forming Polymeric Materials Incorporating Force Probes

The present disclosure provides a method of producing a polymeric material generated from the force probe incorporated resins as described herein. In some embodiments, the method of forming a polymeric material comprises providing a force probe incorporated resin as disclosed herein and curing the resin with a light source, thereby forming a force probe incorporated polymeric material. In some embodiments, the force probes are incorporated into the polymeric material. In some embodiments, the incorporation occurs by intermixing. In some embodiments the intermixing results in the force probes, attaching to the polymeric material. In some embodiments, the attachment is a covalent bond, an electrostatic interaction, or hydrogen bonding. In some embodiments, the force probes are coupled to the polymeric material. In some embodiments, the coupling is a covalent bond or hydrogen bonding.

In some embodiments, the method further comprises the step of fabricating a device using an additive manufacturing device, wherein said additive manufacturing device facilitates the curing. In some embodiments, the method further comprises the step of fabricating an object using an additive manufacturing device, wherein said additive manufacturing device facilitates the curing In some embodiments, the curing of the resin produces the polymeric material. In certain embodiments, the resin is cured using an additive manufacturing device to produce the polymeric material.

In some embodiments, the method further comprises fabricating an object with the polymeric material. In some embodiments, the object is a device as disclosed herein. In some embodiments, the device is an orthodontic appliance. In some embodiments, the orthodontic appliance is an aligner, expander, spacer, or any combination thereof.

In some embodiments, the method further comprises the step of cleaning the polymeric material. In certain embodiments, the cleaning of the polymeric material includes washing and/or rinsing the polymeric material with a solvent, which can remove monomers and undesired impurities from the polymeric material.

In some embodiments, the methods disclosed herein are part of a high temperature lithography-based photopolymerization process, wherein a curable composition (i.e., the force probe incorporated resin) comprises at least one photopolymerization initiator and is heated, which makes high temperature lithography-based photopolymerization process more preferably an additive manufacturing process, most preferably a 3D printing process. The method according to the present disclosure offers the possibility of quickly and facilely producing devices, such as orthodontic appliances, by additive manufacturing such as 3D printing using the force probe incorporated resins as disclosed herein.

Photopolymerization occurs when suitable formulations (e.g., the force probe incorporated resins disclosed herein) are exposed to radiation (e.g., UV or visible light) of sufficient power and of a wavelength capable of initiating polymerization. The wavelengths and/or power of radiation useful to initiate polymerization may depend on the photoinitiator used. “Light” as used herein includes any wavelength and power capable of initiating polymerization. Some wavelengths of light include ultraviolet (UV), visible, or infrared. UV light sources include UVA (wavelength about 400 nanometers (nm) to about 320 nm), UVB (about 320 nm to about 290 nm) or UVC (about 290 nm to about 100 nm). Any suitable source may be used, including laser sources. The source may be broadband or narrowband, or a combination thereof. The light source may provide continuous light, pulsed light, or both continuous and pulsed light during the process. Both the length of time the system is exposed to light and the intensity of the light can be varied to determine the ideal reaction conditions.

In some embodiments, the methods disclosed herein use additive manufacturing to produce a device comprising the force probe incorporated polymeric material disclosed herein. In certain embodiments, the methods disclosed herein use additive manufacturing to produce a device consisting essentially of the polymeric material. Additive manufacturing includes a variety of technologies which fabricate three-dimensional objects directly from digital models through an additive process. In some aspects, successive layers of material are deposited and “cured in place”. A variety of techniques are known to the art for additive manufacturing, including selective laser sintering (SLS), fused deposition modeling (FDM) and jetting or extrusion. In many embodiments, selective laser sintering involves using a laser beam to selectively melt and fuse a layer of powdered material according to a desired cross-sectional shape in order to build up the object geometry. In many embodiments, fused deposition modeling involves melting and selectively depositing a thin filament of thermoplastic polymer in a layer-by-layer manner in order to form an object. In yet another example, 3D printing can be used to fabricate the appliances herein. In many embodiments, 3D printing involves jetting or extruding one or more materials (e.g., the force probe incorporated resins disclosed herein) onto a build surface in order to form successive layers of the object geometry. In some embodiments, the force probe incorporated resins described herein can be used in inkjet or coating applications. Polymeric materials may also be fabricated by “vat” processes in which light is used to selectively cure a vat or reservoir of the curable resin (e.g., the force probe incorporated resins disclosed herein). Each layer of curable resin may be selectively exposed to light in a single exposure or by scanning a beam of light across the layer. Specific techniques include sterolithography (SLA), Digital Light Processing (DLP), holographic projection, and two photon-induced photopolymerization (TPIP).

In some embodiments, the methods disclosed herein use continuous direct fabrication to produce a device comprising the force probe incorporated polymeric material. In certain embodiments, the methods disclosed herein use continuous direct fabrication to produce a device consisting essentially of the force probe incorporated polymeric material. A non-limiting exemplary direct fabrication process can achieve continuous build-up of an object geometry by continuous movement of a build platform (e.g., along the vertical or Z-direction) during an irradiation phase, such that the hardening depth of the irradiated photopolymer (e.g., the irradiated resin, hardening during the formation of the polymeric material) is controlled by the movement speed. Accordingly, continuous polymerization of material (e.g., polymerization of the resin into the polymeric material) on the build surface can be achieved. Such methods are described in U.S. Pat. Nos. 7,892,474 and 10,162,264, the disclosures of which are incorporated herein by reference in their entireties. In yet another example, a continuous direct fabrication method utilizes a “heliolithography” approach in which the liquid resin (e.g., the force probe incorporated resin) is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety. Continuous liquid interface production of 3D objects has also been reported (J. Tumbleston et al., Science, 2015, 347 (6228), pp 1349-1352) hereby incorporated by reference in its entirety for description of the process. Another example of continuous direct fabrication method can involve extruding a material composed of a polymeric material surrounding a solid strand. The material can be extruded along a continuous three-dimensional path in order to form the object. Such methods are described in U.S. Patent Publication No. 2014/0061974, the disclosure of which is incorporated herein by reference in its entirety.

In some embodiments, the methods disclosed herein use high temperature lithography to produce a device comprising the force probe incorporated polymeric material. In certain embodiments, the methods disclosed herein use high temperature lithography to produce a device consisting essentially of the force probe incorporated polymeric material. “High temperature lithography,” as used herein, may refer to any lithography-based photopolymerization processes that involve heating photopolymerizable material(s) (e.g., curable resins disclosed herein). The heating may lower the viscosity of the photopolymerizable material(s) before and/or during curing. Non-limiting examples of high-temperature lithography processes include those processes described in WO 2015/075094, WO 2016/078838 and WO 2018/032022, the disclosures of each of which are incorporated herein by reference in their entirety. In some implementations, high-temperature lithography may involve applying heat to material to temperatures between 50° C.-120° C., such as 90° C.-120° C., 100° C.-120° C., 105° C.-115° C., 108° C.-110° C., etc. The material may be heated to temperatures greater than 120° C. It is noted that other ranges may be used without departing from the scope and substance of the inventive concepts described herein.

In another embodiment, the methods disclosed herein comprise a continuous direct fabrication step. The continuous direct fabrication step can involve extruding a material composed of a curable liquid material (e.g., the force probe incorporated resin) surrounding a solid strand. The liquid material can be extruded along a continuous three-dimensional path in order to form an object or device. Such methods are described in U.S. Patent Publication No. 2014/0061974, the disclosure of which is incorporated herein by reference in its entirety.

In another embodiments, the methods disclosed herein provide methods of producing 3-D printed devices. In some embodiments, the method of producing a 3D printed orthodontic appliance, comprises direct fabrication of the orthodontic appliance, and optionally wherein the direct fabrication comprises cross-linking a force probe incorporated resin as disclosed herein. In some embodiments, the orthodontic appliance is one of a plurality of orthodontic appliances having a sequential order.

In certain embodiments, the methods disclosed herein further comprises fabricating an object with the polymeric material. In certain embodiments, fabricating the object comprises additive manufacturing. Fabricating the object using additive manufacturing produces an object comprising a plurality of additively formed layers. In some embodiments, fabricating the object with the polymeric material comprises printing with a 3D printer. In some embodiments, fabricating the object with the polymeric material comprises digital light projection. In certain embodiments, fabricating the object with the polymeric material comprises using hot lithography. In some embodiments, the fabricating comprises printing with a 3D printer. In some embodiments, the 3D printed orthodontic appliance is the orthodontic appliance as disclosed herein. In some embodiments, the fabricating comprises high temperature lithography. In some embodiments, the fabricating comprises digital light projection.

In some embodiments, the object as disclosed herein is an orthodontic appliance. In some embodiments, the orthodontic appliance is an aligner, expander or spacer. In some embodiments wherein the orthodontic appliance is an aligner. In some embodiments, the orthodontic appliance comprises a plurality of tooth receiving cavities configured to reposition teeth from a first configuration toward a second configuration. In some embodiments, the orthodontic appliance is one of a plurality of orthodontic appliances configured to reposition the teeth from an initial configuration toward a target configuration. In some embodiments, the orthodontic appliance is one of a plurality of orthodontic appliances configured to reposition the teeth from an initial configuration toward a target configuration according to a treatment plan. In some embodiments, the method of treatment further comprises detecting an emission from the at least one force probe, and instructing a user to apply to the patient's teeth the next orthodontic appliance from the sequence. In some embodiments, the user and the patient are the same. In some embodiments, the user is instructed to apply the next orthodontic appliance from the sequence to the patient's teeth less than 14 days, less than 13 days, less than 12 days, less than 11 days, less than 10 days, less than 9 days, less than 8 days, less than 7 days, less than 6 days, less than 5 days, or less than 4 days after applying the previous orthodontic appliance.

### Devices Using Force Probes

The present disclosure provides devices comprising the force probe incorporated polymeric materials generated from the force probe incorporated resins as described herein. In some embodiments, the force probe incorporated polymeric material is used to create a device intended to be placed in the intraoral cavity of a human. Such devices can be, for example, aligners that help to move teeth to new positions. In some embodiments, the devices can be retainers that help to keep teeth from moving to a new position. In some embodiments, the device can be used to expand the palate, move the location of the jaw, or prevent snoring of a human.

The present disclosure provides methods for producing the devices described herein, said devices comprising a force probe incorporated polymeric material. In some embodiments, the method comprises a step of shaping a force probe incorporated resin into a desirable shape prior to a step of curing the force probe incorporated resin, thereby generating the force probe incorporated polymeric material having said desirable shape. In some embodiments, the method comprises a step of shaping a force probe incorporated resin into a desirable shape during a step of curing the force probe incorporated resin, thereby generating the polymeric material having said desirable shape. In some embodiments, the method comprises a step of curing the force probe incorporated resin, thereby forming the force probe incorporated polymeric material, then shaping the force probe incorporated polymeric material into a desirable shape. In some embodiments, the desirable shape is a force probe incorporated orthodontic appliance. In some embodiments, the desirable shape is a device and/or object as disclosed herein. In some embodiments, the shaping step comprises extrusion, production of a sheet, production of a film, melt spinning, coating, injection molding, compression and transfer molding, blow molding, rotational blow molding, thermoforming, casting, or a combination thereof. In some embodiments, the polymeric materials described herein are thermoplastic or thermoset. In certain embodiments, the thermoplastic(s) tend to perform better with molding techniques, though the properties of the materials disclosed herein allow for thermosets to be molded. In some embodiments, the materials disclosed herein are shape memory materials.

Exemplary embodiments of devices that can be cured using the materials disclosed herein include dental appliances for use in humans. In some embodiments, such devices can be used as treatment systems for providing an orthodontic treatment.

In certain aspects, the present disclosure provides a method of making an orthodontic appliance comprising a force probe incorporated polymeric material as described herein, the method comprising providing a force probe incorporated resin as further described herein; and fabricating the force probe incorporated polymeric material by a direct or additive fabrication process. The force probe incorporated resin may be exposed to light in said direct or additive fabrication process. The process may further comprise an additional curing step following fabrication of the polymeric material.

In certain aspects, the present disclosure provides an orthodontic appliance comprising a force probe incorporated polymeric material as further described herein. The orthodontic appliance may be an aligner, expander or spacer. In some embodiments, the orthodontic appliance comprises a plurality of tooth receiving cavities configured to reposition teeth from a first configuration toward a second configuration. In some embodiments, the orthodontic appliance is one of a plurality of orthodontic appliances configured to reposition the teeth from an initial configuration toward a target configuration, optionally according to a treatment plan. As used herein a “plurality of teeth” encompasses two or more teeth.

In many embodiments, one or more posterior teeth comprises one or more of a molar, a premolar or a canine, and one or more anterior teeth comprising one or more of a central incisor, a lateral incisor, a cuspid, a first bicuspid or a second bicuspid.

The curable resins and cured polymeric materials according to the present disclosure exhibit favorable thermomechanical properties for use as orthodontic appliances, for example, for moving one or more teeth.

The curable resins (e.g., force probe incorporated resins) and cured polymeric materials (e.g., force probe incorporated polymeric materials) according to the present disclosure exhibit favorable optical properties for use as orthodontic appliances. For example, measuring an emission spectrum of an orthodontic appliance on a patient and determining if the patient is ready for next orthodontic appliance from a sequence of orthodontic appliances based on the measured emission spectrum.

The embodiments disclosed herein can be used to couple groups of one or more teeth to each other. The groups of one or more teeth may comprise a first group of one or more anterior teeth and a second group of one or more posterior teeth. The first group of teeth can be coupled to the second group of teeth with the polymeric shell appliances as disclosed herein.

The embodiments disclosed herein are well suited for moving one or more teeth of the first group of one or more teeth or moving one or more of the second group of one or more teeth, and combinations thereof.

The embodiments disclosed herein are well suited for combination with one or known commercially available tooth moving components such as attachments and polymeric shell appliances. In many embodiments, the appliance and one or more attachments are configured to move one or more teeth along a tooth movement vector comprising six degrees of freedom, in which three degrees of freedom are rotational and three degrees of freedom are translation.

The present disclosure provides orthodontic systems and related methods for designing and providing improved or more effective tooth moving systems for eliciting a desired tooth movement and/or repositioning teeth into a desired arrangement.

Although reference is made to an appliance comprising a polymeric shell appliance, the embodiments disclosed herein are well suited for use with many appliances that receive teeth, for example appliances without one or more of polymers or shells. The appliance can be fabricated with one or more of many materials such as metal, glass, reinforced fibers, carbon fiber, composites, reinforced composites, aluminum, biological materials, and combinations thereof for example. In some cases, the reinforced composites can comprise a polymer matrix reinforced with ceramic or metallic particles, for example. The appliance can be shaped in many ways, such as with thermoforming or direct fabrication as described herein, for example. Alternatively, or in combination, the appliance can be fabricated with machining such as an appliance fabricated from a block of material with computer numeric control machining. Preferably, the appliance is fabricated using a force probe incorporated resin according to the present disclosure.

### Orthodontic Devices Comprising Force Probes

The present disclosures provides a force probe incorporated orthodontic appliance as disclosed herein can provide favorable treatment properties. In some embodiments, the orthodontic appliance comprises force probes as disclosed herein. In some embodiments, the orthodontic appliance comprises a first polymeric material and a force probe incorporated into the polymeric material. In some embodiments, the force probe when in an unstrained configuration comprises a first emission spectrum; and when in a strained configuration comprises a second emission spectrum, wherein the first emission spectrum and the second emission spectrum are distinct from one another. In some embodiments, a transition between the first emission spectrum and the second emission spectrum occurs when a force is applied to the orthodontic appliance. In some embodiments, a transition between the unstrained configuration and the strained configuration occurs when a force is applied to the orthodontic appliance. In some embodiments, the force comprises a mechanical force. In some embodiments, the mechanical force comprises application of the orthodontic appliance to a patient's teeth. In some embodiments, the force probe is a Förster-based probe or a mechanophore.

In some embodiments, the force probe comprises a detectable fluorophore, the detectable fluorophore having an emission spectrum. In some embodiments, the detectable fluorophore has a first detectable emission responsive to a first contact force and a second detectable emission responsive to a second contact force. In some embodiments, a transition between the first detectable emission and the second detectable emission occurs when a mechanical force is applied to the orthodontic appliance. In some embodiments, the emission spectrum is the emission wavelength. In some embodiments, the emission wavelength is the maximum emission wavelength.

In some embodiments, the force probe in the orthodontic appliance comprises a flexible tether, and wherein the photon absorber and the detectable fluorophore are each coupled to the flexible tether. In some embodiments, the flexible tether comprises a polymer chain or a peptide chain. In some embodiments, the flexible tether comprises polyethylene glycol. In some embodiments, the flexible tether is a polymer chain. In some embodiments, the flexible tether is a peptide chain. In some embodiments, the flexible tether is ethylene glycol. In some embodiments, the ethylene glycol linker is represented by (—(CH₂CH₂—O)—)ₙ. In some embodiments n is represented by 1, 2, 3, 4, 5, 6, 7, 8, 9, 10, 20, 50, 100, or 200. In some embodiments, n is at least 1, at least 5, at least 10, at least 20, at least 50, at least 100, at least 200. In some embodiments, n is at most 1, at most 5, at most 10, at most 20, at most 50, at most 100, at most 200. In some embodiments, the polymer chain comprises repeating ethylene glycol units. In some embodiments, the repeating unit comprises at least 1, at least 5, at least 10, at least 20, at least 50, at least 100, at least 200 ethylene glycol units. In some embodiments, the ethylene glycol linker is functionalized on at least one end of the linker. In some embodiments, the ethylene glycol linker is functionalized with by an amide or thiol group. In some embodiments, the ethylene glycol linker is functionalized on both ends by an amide group.

In some embodiments, the orthodontic appliance comprises a transition between the first detectable emission and the second detectable emission comprises a change in the maximum emission wavelength. In some embodiments, the change in the maximum emission wavelength is at least 400 nm, at least 300 nm, at least 200 nm, at least 100 nm, at least 90 nm, at least 80 nm, at least 70 nm, at least 60 nm, at least 50 nm, at least 40 nm, at least 30 nm, at least 20 nm, or at least 10 nm. In some embodiments, the change in the maximum emission wavelength is at most 400 nm, at most 300 nm, at most 200 nm, at most 100 nm, at most 90 nm, at most 80 nm, at most 70 nm, at most 60 nm, at most 50 nm, at most 40 nm, at most 30 nm, at most 20 nm, or at most 10 nm. In some embodiments, the change in the maximum emission wavelength is at least 20 nm. In some embodiments, maximum emission wavelength is between 200 nm to 800 nm, 200 nm to 700 nm, 200 nm to 600 nm, 200 nm to 500 nm, 200 nm to 400 nm, or 200 nm to 300 nm. In some embodiments, the maximum emission wavelength is between 300 nm to 800 nm, 400 nm to 800 nm, 500 nm to 800 nm, 600 nm to 800 nm, or 700 nm to 800 nm. In some embodiments, the maximum emission corresponds with the force applied to the orthodontic appliance. In some embodiments, the maximum emission corresponds linearly with the force applied to the orthodontic appliance.

In some embodiments, the orthodontic appliance comprises a localized region, the localized region comprising: the force probe; at least some of the polymeric material; and an area less than 100 nm in any direction from the force probe, wherein the mechanical force comprises a force greater than 1 pN applied to the localized region. In some embodiments, the localized area is less than 500 nm, less than 400 nm, less than 300 nm, less than 200 nm, less than 100 nm, less than 90 nm, less than 80 nm, less than 70 nm, less than 60 nm, or less than 50 nm in any direction from the force probe. In some embodiments, the localized area is more than 500 nm, more than 400 nm, more than 300 nm, more than 200 nm, more than 100 nm, more than 90 nm, more than 80 nm, more than 70 nm, more than 60 nm, or more than 50 nm in any direction from the force probe. In some embodiments, the mechanical force comprises a force greater than 1 pN, greater than 2 pN, greater than 3 pN, greater than 4 pN, greater than 5 pN, greater than 6 pN, greater than 7 pN, greater than 8 pN, greater than 9 pN, greater than 10 pN, greater than 25 pN, greater than 50 pN, greater than 100 pN, greater than 200 pN, greater than 300 pN, greater than 400 pN, greater than 500 pN, greater than 1000 pN, greater than 1500 pN, or greater than 2000 pN applied to a localized region. In some embodiments, the mechanical force comprises a force less than 2000 pN, less than 1500 pN, less than 1000 pN, less than 500 pN, less than 400 pN, less than 200 pN, less than 100 pN, or less than 50 pN applied to a localized region. In some embodiments, a transition between the first emission spectrum and the second emission spectrum occurs when the mechanical force is applied. In some embodiments, the orthodontic appliance comprises a plurality of localized regions.

In some embodiments, the orthodontic appliance comprises 0.01-10 wt %, 0.01-5 wt %, 0.01-4 wt %, 0.01-3 wt %, 0.01-2 wt %, or 0.01-1 wt % of the force probes. In some embodiments, the orthodontic appliance comprises 0.01-2 wt % of the force probes. In some embodiments, the orthodontic appliance comprises 0.01-10 wt %, 0.02-5 wt %, 0.05-4 wt %, 0.1-3 wt %, 0.1-2 wt %, or 0.1-1 wt % of the force probes. In some embodiments, the orthodontic appliance comprises 0.1-2 wt % of the force probes. In some embodiments, the orthodontic appliance comprises 0.01-5 wt % of the force probe. In some embodiments, the orthodontic appliance comprises at most 5 wt % of the force probe. In some embodiments, the force probe further comprises a photon absorber. In some embodiments, the photon absorber is a quencher.

In some embodiments, the orthodontic appliance comprises a photon absorber coupled to a detectable fluorophore. In some embodiments, the orthodontic appliance comprises a detectable fluorophore that has an emission spectrum. In some embodiments, the detectable fluorophore has a first detectable emission responsive to a first contact force and a second detectable emission responsive to a second contact force. In some embodiments, the transition between the first detectable emission and the second detectable emission occurs when a mechanical force is applied to the orthodontic appliance. In some embodiments, the detectable fluorophore comprises a xanthene derivative, a cyanine derivative, a squaraine derivative, a naphthalene derivative, a coumarin derivative, an oxadiazole derivative, an anthracene derivative, a pyrene derivative, an oxazine derivative, an acridine derivative, an arylmethine derivative, a tetrapyrrole derivative, or a combination thereof.

In preferred embodiments, orthodontic appliance comprises a detectable fluorophore that has an emission spectrum that overlaps with an absorption spectrum of the quencher. In some embodiments, at least 10%, at least 20%, at least 30%, at least 40%, at least 50%, at least 55%, at least 60%, at least 65%, at least 70%, at least 75%, at least 80%, at least 85%, at least 90%, at least 95%, at least 96%, at least 97%, at least 98%, or at least 99% of an area of the absorption spectrum of the quencher overlaps with the emission spectrum of the detectable fluorophore. In some embodiments, at least 50% of an area of the absorption spectrum of the quencher overlaps with the emission spectrum of the detectable fluorophore. In some embodiments, at least 10% of an area of the absorption spectrum of the quencher overlaps with the emission spectrum of the detectable fluorophore. In some embodiments, the quencher comprises 4-(dimethylaminoazo)benzene-4-carboxylic acid, a DDQ quencher, a BHQ quencher, a QSY quencher, a derivative thereof, or a combination thereof.

In some embodiments, the photon absorber of the orthodontic appliance is a second fluorophore. In some embodiments, the second fluorophore comprises a xanthene derivative, a cyanine derivative, a squaraine derivative, a naphthalene derivative, a coumarin derivative, an oxadiazole derivative, an anthracene derivative, a pyrene derivative, an oxazine derivative, an acridine derivative, an arylmethine derivative, a tetrapyrrole derivative, or a combination thereof.

In some embodiments, the orthodontic appliance comprises at least 10%, at least 20%, at least 30%, at least 40%, at least 50%, at least 55%, at least 60%, at least 65%, at least 70%, at least 75%, at least 80%, at least 85%, at least 90%, at least 95%, at least 96%, at least 97%, at least 98%, or at least 99% of an area of the absorption spectrum of the second fluorophore overlaps with the emission spectrum of the detectable fluorophore. In some embodiments, the orthodontic appliance comprises at least 50% of an area of the absorption spectrum of the second fluorophore overlaps with the emission spectrum of the detectable fluorophore. In some embodiments, the orthodontic appliance comprises at least 10% of an area of the absorption spectrum of the second fluorophore overlaps with the emission spectrum of the detectable fluorophore. In some embodiments, the orthodontic appliance comprises at least 10% of an area of the absorption spectrum of the quencher overlaps with the emission spectrum of the detectable fluorophore.

In some embodiments, the orthodontic appliance comprises a photon absorber and a detectable fluorophore that have a Förster distance. In some embodiments, the distance between the detectable fluorophore and the photon absorber in the orthodontic appliance at rest is at most 1.5-fold the Förster distance. In some embodiments, the distance between the detectable fluorophore and the photon absorber is at least 0.5-fold the Förster distance when the mechanical force is applied to the orthodontic appliance.

In some embodiments, the detectable fluorophore of the orthodontic appliance comprises a single-molecule force probe. In some embodiments, the force probe of the orthodontic appliance is a single-molecule force probe (e.g. a mechanophore as described herein) selected from the group consisting of a spiropyran, an aromatic disulfide, a nitroxyl, a stilbene, and a dye. In some embodiments, the force probe is luminescent. In some embodiments, the force probe is fluorescent or phosphorescent. In some embodiments, the mechanophore is localized regions in the orthodontic appliance. In some embodiments, the mechanophore is distributed through the orthodontic appliance.

In some embodiments, the force probe is coupled to the polymeric material. In some embodiments, the force probe is incorporated into the backbone of the polymeric material. In some embodiments, the force probe is intermixed with the polymeric material (for example, equally dispersed and incorporated into the backbone of the polymeric material). In some embodiments, the force probe is coupled to the polymeric material by hydrogen bonding. In some embodiments, the detectable fluorophore is coupled to the polymeric material, and wherein the photon absorber is attached to a second polymeric material.

In some embodiments, the orthodontic appliance comprises a detectable fluorophore and a photon absorber that are separated by a distance of at most 10 nm when the orthodontic appliance is at rest. In some embodiments, the detectable fluorophore and the photon absorber are separated by a distance of at most 100 nm, at most 50 nm, at most 25 nm, at most 20 nm, at most 15 nm, at most 10 nm, at most 10 nm, at most 9 nm, at most 8 nm, at most 7 nm, at most 6 nm, or at most 5 nm when the orthodontic appliance is at rest. In some embodiments, the detectable fluorophore and the photon absorber are separated by a distance of at least 25 nm, at least 20 nm, at least 15 nm, at least 10 nm, at least 10 nm, at least 9 nm, at least 8 nm, at least 7 nm, at least 6 nm, or at least 5 nm when the orthodontic appliance is at rest.

In some embodiments, the transition between the first detectable emission and the second detectable emission comprises a change in the maximum emission wavelength. In some embodiments, the change in the maximum emission wavelength is at least 400 nm, at least 300 nm, at least 200 nm, at least 100 nm, at least 90 nm, at least 80 nm, at least 70 nm, at least 60 nm, at least 50 nm, at least 40 nm, at least 30 nm, at least 20 nm, or at least 10 nm. In some embodiments, the change in the maximum emission wavelength is at most 400 nm, at most 300 nm, at most 200 nm, at most 100 nm, at most 90 nm, at most 80 nm, at most 70 nm, at most 60 nm, at most 50 nm, at most 40 nm, at most 30 nm, at most 20 nm, or at most 10 nm. In some embodiments, the change in the maximum emission wavelength is at least 20 nm.

In some embodiments, the transition between the first detectable emission and the second detectable emission corresponds with the mechanical force that is applied to the orthodontic appliance. In some embodiments, the transition between the first detectable emission and the second detectable emission corresponds linearly with the mechanical force that is applied to the orthodontic appliance.

In some embodiments, the orthodontic appliance is an aligner, expander, spacer, or any combination thereof. In some embodiments, the orthodontic appliance comprises a plurality of tooth receiving cavities configured to reposition teeth from a first configuration toward a second configuration. In some embodiments, the orthodontic appliance is one of a plurality of orthodontic appliances configured to reposition the teeth from an initial configuration toward a target configuration. In some embodiments, the orthodontic appliance is one of a plurality of orthodontic appliances configured to reposition the teeth from an initial configuration toward a target configuration according to a treatment plan.

In various embodiments, the present disclosure provides an orthodontic appliance comprising a polymeric material and means for probing an emission spectrum of the polymeric material. In some embodiments, the means for probing comprises a first emission spectrum when in an unstrained configuration, and a second emission spectrum when in a strained configuration. In some embodiments, the first emission spectrum and the second emission spectrum are distinct from one another. In some embodiments, a transition between the unstrained configuration and the strained configuration occurs when a force is applied to the orthodontic appliance. In certain embodiments, the force comprises a mechanical force comprising application of the orthodontic appliance to a patient's teeth.

### Methods of Detecting Forces in Devices

The present disclosure provides methods of detecting force in devices based on an emission wavelength. For example, detecting the force applied by an orthodontic appliances such as aligners, can help aid in moving teeth to new positions as a part of a treatment plan. In some embodiments, the devices can be retainers that help to keep teeth from moving to a new position. By way of example, measuring the force applied by a retainer can aid in determining the efficacy of the device over a period of time. In some embodiments, the method of detecting a force comprises an orthodontic device as disclosed herein or produced by the methods provided herein and detecting an emission from the force probe. In preferred embodiments, the detected emission is from a force probe as described herein. In some embodiments, the method of detecting an emission from a force probe comprises a method of detecting as disclosed herein. In some embodiments, the method of detecting an emission from a force probe incorporated device comprises a method of detecting as described herein. In preferred embodiments, the method of detecting an emission from a force probe incorporated orthodontic appliance comprises a method of detecting as disclosed herein. Procedures for detecting the amount of forces in molecular force probes are provided in G. Gossweiler et al., J. Am. Chem. Soc., 2015, 137 (19), pp 6148-6151 and C. Jurchenko et al., Mol Cell Biol., 2015, 35 (15), pp 2570-2582, the disclosures of each of which are incorporated herein by reference in their entirety.

In some embodiments, the orthodontic appliance comprises a plurality of force probes, each comprising a detectable emission that changes when a mechanical force is applied to the orthodontic appliance. In some embodiments, the mechanical force comprises application of the orthodontic appliance to a patient's teeth. In some embodiments, detecting the emission from the force probe provides a measure of the mechanical force.

In some embodiments, detecting the emission from the force probe informs a user to continue application of the orthodontic appliance to the patient's teeth or to apply a next orthodontic appliance from a sequence of orthodontic appliances to the patient's teeth.

In some embodiments, the mechanical force comprises bonding the orthodontic appliance to the patient's teeth. In some embodiments, the mechanical force comprises testing the orthodontic appliance during manufacture. In some embodiments, testing the orthodontic appliance occurs during or after orthodontic appliance removal during manufacture.

In some embodiments, the detectable emission informs on warpage or breakage of the orthodontic appliance. In some embodiments, the orthodontic appliance causes a strained conformation of at least one force probe in the orthodontic appliance that informs the user on warpage or breakage. In some embodiments, the orthodontic appliance causes a change in the detectable emission of at least one force probe in the orthodontic appliance that informs the user on warpage or breakage. In some embodiments, detecting the emission from the force probe informs on an amount of stress imposed onto the orthodontic appliance. In some embodiments, detecting the emission from the force probe informs on rate of relaxation of the orthodontic appliance in combination with tooth movement.

In some embodiments, detecting the detectable emission from the force probe comprises detecting the detectable emission from at least some of the plurality of force probes. In some embodiments, the change in detectable emission corresponds with the mechanical force applied to the orthodontic appliance. In some embodiments, the change in detectable emission corresponds linearly with the mechanical force that is applied to the orthodontic appliance.

In some embodiments, the method further comprises measuring the change in the detectable emission. In some embodiments, the change in the detectable emission is measured with a comparison to the orthodontic appliance at rest.

In some embodiments, the change in the detectable emission is measured with a comparison to a non-strained portion of the orthodontic appliance, wherein non-strained portion comprises less than 10% volume, less than 9% volume, less than 8% volume, less than 7% volume, less than 6% volume, less than 5% volume, less than 4% volume, less than 3% volume, less than 2% volume, or less than 1% volume of material that was enacted upon by the mechanical force. In some embodiments, the change in the detectable emission is measured with a comparison to a non-strained portion of the orthodontic appliance, wherein non-strained portion comprises less than 10% volume of material that was enacted upon by the mechanical force. In some embodiments, the change in the detectable emission comprises a comparison with a detectable emission of the non-strained portion. In some embodiments, the detecting takes place while the orthodontic appliance is attached to a patient's teeth.

In some embodiments, the detecting takes place a kit as described herein.

In some embodiments, the measuring comprises a relative measurement of internal stress. In some embodiments, the measuring comprises an actual measurement of internal stress.

In some embodiments, the method further comprising receiving an indication the orthodontic appliance should be replaced. In some embodiments, the indication the orthodontic appliance should be replaced is associated with the emission from the force probe. In some embodiments, the orthodontic appliance is one of a plurality of orthodontic appliances, and receiving the indication the orthodontic appliance should be replaced triggers instructing a user to use another one of the plurality of orthodontic appliances.

In some embodiments, the method further comprising determining a stress value of the orthodontic appliance. In some embodiments, determining the stress value can provide a relative stress measurement.

### Method of Detecting Stress in Devices

The present disclosure provides a method of detecting stress in devices. For example, orthodontic appliances such as aligners can help to move teeth to new positions. In some embodiments, the devices can be retainers that help to keep teeth from moving to a new position. The method comprises using a device as disclosed herein incorporated with at one force probe as described herein. In some embodiments, the method of detecting stress comprises a method as disclosed herein. In some embodiments, the method of detecting stress on an orthodontic appliance comprises applying an orthodontic appliance comprising a force probe to a patient's teeth; and detecting a level of emission from the force probe, wherein the emission from the force probe corresponds with a mechanical force. In some embodiments, the mechanical force comprises a force to move the patient's teeth. In some embodiments, the method further comprising moving the patient's teeth from an initial position toward a final position. In some embodiments, the initial position will have an initial position emission wavelength and the final position will have a final position emission wavelength. Procedures for detecting an amount of stress are provided in G. Gossweiler et al., J. Am. Chem. Soc., 2015, 137 (19), pp 6148-6151 and C. Jurchenko et al., Mol Cell Biol., 2015, 35 (15), pp 2570-2582, the disclosures of each of which are incorporated herein by reference in their entirety.

In some embodiments, the method further comprises instructing based on the level of emission, the continued application of the orthodontic appliance to the patient's teeth. In some embodiments, instructing the continued application of the orthodontic appliance to the patient's teeth includes measuring the level of emission at or above a threshold value.

In some embodiments, the method further comprising instructing, based on the level of emission, the application of a next orthodontic appliance from a sequence of orthodontic appliances to the patient's teeth. In some embodiments, instructing the application of the next orthodontic appliance to the patient's teeth includes measuring the level of emission below a threshold value. In some embodiments, the orthodontic appliance, when comprising mechanical force sufficient to move at least one of the patient's teeth has the level of emission at or above a threshold value, and when comprising a mechanical force that is not sufficient to move at least one of the patient's teeth has the level of emission below the threshold value.

In some embodiments, the method further comprising instructing a user to remove the orthodontic appliance from the patient's teeth when the level of emission is below the threshold value, and to apply a next orthodontic appliance from a sequence of orthodontic appliances to the patient's teeth.

In some embodiments, the user is instructed to apply the next orthodontic appliance from the sequence of orthodontic appliances to the patient's teeth less than 14 days, less than 13 days, less than 12 days, less than 11 days, less than 10 days, less than 9 days, less than 8 days, less than 7 days, less than 6 days, less than 5 days, or less than 4 days after applying the previous orthodontic appliance. In some embodiments, a user is instructed to apply a next orthodontic appliance from a sequence of orthodontic appliances at a time earlier than corresponding conventional orthodontic appliances.

### Kits

The present disclosure provides a kit for measuring an emission of an orthodontic appliance. The kit can be useful in measuring the forces or detecting stress in a device. In some embodiments, the kit comprises the orthodontic appliance as disclosed herein and a case, the case comprising: a light emitting source, and a detector. In some embodiments, the light emitting source emits at least one wavelength. In some embodiments, the source emits a wavelength that is absorbed by the orthodontic appliance.

In some embodiments, the detector is an optical detector. In some embodiments, the optical detector is selected from the group consisting of a charge-coupled device, an active-pixel sensor, a contact image sensor, an electro-optical sensor, an infra-red sensor, a kinetic inductance detector, a light emitting diode, a light-addressable potentiometric sensor, a fiber optic sensor, a thermopile laser sensor, a photodetector, a photodiode, a photomultiplier, a phototransistor, a photoelectric sensor, a photoionization detector, a photomultiplier, a photoresistor, a photoswitch, a phototube, a single-photon avalanche diode, a visible-light photon counter, and a wavefront sensor. In some embodiments, the optical detector comprises a camera. In some embodiments, the detector detects at least one wavelength. In some embodiments, the kit further comprises instructions.

### Orthodontic Appliances and Methods of Forming the Same

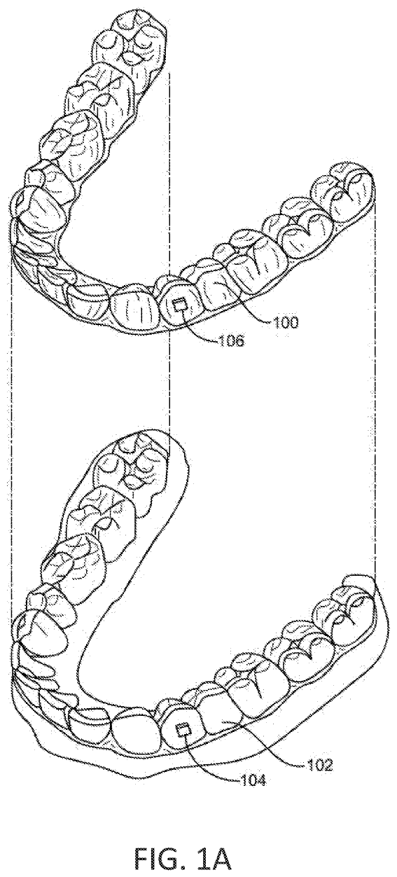

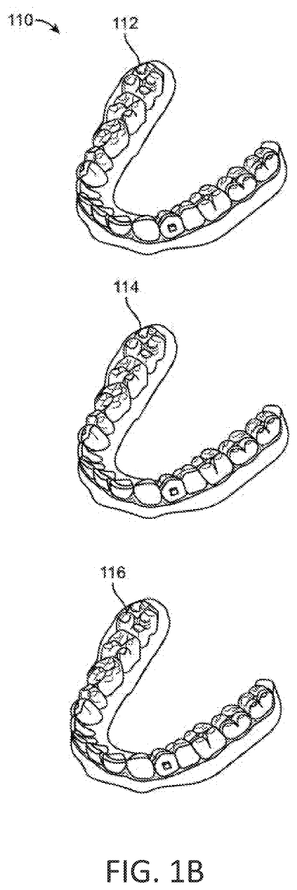

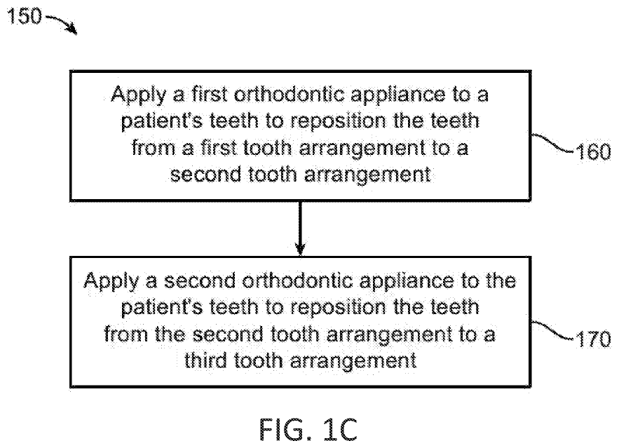

Turning now to the drawings, in which like numbers designate like elements in the various figures, FIG. 1A illustrates an exemplary tooth repositioning appliance or aligner (100) that can be worn by a patient in order to achieve an incremental repositioning of individual teeth (102) in the jaw, and comprises the cured polymeric material disclosed herein. The appliance can include a shell (e.g., a continuous polymeric shell or a segmented shell) having teeth-receiving cavities that receive and resiliently reposition the teeth. An appliance or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using rapid prototyping fabrication techniques, from a digital model of an appliance. An appliance can fit over all teeth present in an upper or lower jaw, or less than all of the teeth. The appliance can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance can be a generic appliance configured to receive the teeth, but not necessarily shaped to match the topography of the patient's teeth. In some cases, only certain teeth received by an appliance will be repositioned by the appliance while other teeth can provide a base or anchor region for holding the appliance in place as it applies force against the tooth or teeth targeted for repositioning. In some cases, some, most, or even all of the teeth will be repositioned at some point during treatment. Teeth that are moved can also serve as a base or anchor for holding the appliance as it is worn by the patient. Typically, no wires or other means will be provided for holding an appliance in place over the teeth. In some cases, however, it may be desirable or necessary to provide individual attachments or other anchoring elements (104) on teeth (102) with corresponding receptacles or apertures (106) in the appliance (100) so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 1B illustrates a tooth repositioning system (110) including a plurality of appliances (112), (114), (116). Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system (110) can include a first appliance (112) corresponding to an initial tooth arrangement, one or more intermediate appliances (114) corresponding to one or more intermediate arrangements, and a final appliance (116) corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 1C illustrates a method (150) of orthodontic treatment using a plurality of appliances, in accordance with embodiments. The method (150) can be practiced using any of the appliances or appliance sets described herein. In step (160), a first orthodontic appliance is applied to a patient's teeth in order to reposition the teeth from a first tooth arrangement to a second tooth arrangement. In step (170), a second orthodontic appliance is applied to the patient's teeth in order to reposition the teeth from the second tooth arrangement to a third tooth arrangement. The method (150) can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

The various embodiments of the orthodontic appliances presented herein can be fabricated in a wide variety of ways. In some embodiments, the orthodontic appliance comprises a polymeric material and a force probe incorporated into the polymeric material, wherein the polymeric material comprises a plurality of additively formed layers. In some embodiments, the orthodontic appliance comprises a polymeric material and a force probe incorporated into the polymeric material, wherein the polymeric material comprises a thermoplastic material. In some embodiments, the polymeric material is a thermoplastic.

In some embodiments, the orthodontic appliance comprises a plurality of layers. In some embodiments, the orthodontic appliance comprises a plurality of additively formed layers. In certain embodiments, the orthodontic appliance comprises a plurality of additively formed layers of polymeric material. Additively formed layers are those generated during additive manufacturing (also referred to herein as “3D printing”).

In some embodiments, the appliances herein (or portions thereof) can be produced using direct fabrication, such as additive manufacturing techniques (also referred to herein as “3D printing”) or subtractive manufacturing techniques (e.g., milling). An appliance formed using additive manufacturing comprises a plurality of additively formed layers. In some embodiments, direct fabrication involves forming an object (e.g., an orthodontic appliance or a portion thereof) without using a physical template (e.g., mold, mask etc.) to define the object geometry. Additive manufacturing techniques can be categorized as follows: (1) vat photopolymerization (e.g., stereolithography), in which an object is constructed layer by layer from a vat of liquid photopolymer resin; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) fused deposition modeling (FDM), in which material is drawn though a nozzle, heated, and deposited layer by layer; (5) powder bed fusion, including but not limited to direct metal laser sintering (DMLS), electron beam melting (EBM), selective heat sintering (SHS), selective laser melting (SLM), and selective laser sintering (SLS); (6) sheet lamination, including but not limited to laminated object manufacturing (LOM) and ultrasonic additive manufacturing (UAM); and (7) directed energy deposition, including but not limited to laser engineering net shaping, directed light fabrication, direct metal deposition, and 3D laser cladding. For example, stereolithography can be used to directly fabricate one or more of the appliances herein. In some embodiments, stereolithography involves selective polymerization of a photosensitive resin (e.g., a photopolymer) according to a desired cross-sectional shape using light (e.g., ultraviolet light). The object geometry can be built up in a layer-by-layer fashion by sequentially polymerizing a plurality of object cross-sections. As another example, the appliances herein can be directly fabricated using selective laser sintering. In some embodiments, selective laser sintering involves using a laser beam to selectively melt and fuse a layer of powdered material according to a desired cross-sectional shape in order to build up the object geometry. As yet another example, the appliances herein can be directly fabricated by fused deposition modeling. In some embodiments, fused deposition modeling involves melting and selectively depositing a thin filament of thermoplastic polymer in a layer-by-layer manner in order to form an object. In yet another example, material jetting can be used to directly fabricate the appliances herein. In some embodiments, material jetting involves jetting or extruding one or more materials onto a build surface in order to form successive layers of the object geometry.

Alternatively or in combination, some embodiments of the appliances herein (or portions thereof) can be produced using indirect fabrication techniques, such as by thermoforming over a positive or negative mold. Indirect fabrication of an orthodontic appliance can involve producing a positive or negative mold of the patient's dentition in a target arrangement (e.g., by rapid prototyping, milling, etc.) and thermoforming one or more sheets of material over the mold in order to generate an appliance shell.

In some embodiments, the direct fabrication methods provided herein build up the object geometry in a layer-by-layer fashion, with successive layers being formed in discrete build steps. Alternatively or in combination, direct fabrication methods that allow for continuous build-up of an object geometry can be used, referred to herein as “continuous direct fabrication.” Various types of continuous direct fabrication methods can be used. As an example, in some embodiments, the appliances herein are fabricated using “continuous liquid interphase printing,” in which an object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Continuous liquid interphase printing can achieve fabrication speeds about 25 times to about 100 times faster than other direct fabrication methods, and speeds about 1000 times faster can be achieved with the incorporation of cooling systems. Continuous liquid interphase printing is described in U.S. Patent Publication Nos. 2015/0097315, 2015/0097316, and 2015/0102532, the disclosures of each of which are incorporated herein by reference in their entirety.

As another example, a continuous direct fabrication method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety.

In another example, a continuous direct fabrication method can involve extruding a composite material composed of a curable liquid material surrounding a solid strand. The composite material can be extruded along a continuous three-dimensional path in order to form the object. Such methods are described in U.S. Patent Publication No. 2014/0061974, the disclosure of which is incorporated herein by reference in its entirety.

In yet another example, a continuous direct fabrication method utilizes a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

Machine parameters can include curing parameters. For digital light processing (DLP)-based curing systems, curing parameters can include power, curing time, and/or grayscale of the full image. For laser-based curing systems, curing parameters can include power, speed, beam size, beam shape and/or power distribution of the beam. For printing systems, curing parameters can include material drop size, viscosity, and/or curing power. These machine parameters can be monitored and adjusted on a regular basis (e.g., some parameters at every 1-x layers and some parameters after each build) as part of the process control on the fabrication machine. Process control can be achieved by including a sensor on the machine that measures power and other beam parameters every layer or every few seconds and automatically adjusts them with a feedback loop. For DLP machines, gray scale can be measured and calibrated before, during, and/or at the end of each build, and/or at predetermined time intervals (e.g., every nth build, once per hour, once per day, once per week, etc.), depending on the stability of the system. In addition, material properties and/or photo-characteristics can be provided to the fabrication machine, and a machine process control module can use these parameters to adjust machine parameters (e.g., power, time, gray scale, etc.) to compensate for variability in material properties. By implementing process controls for the fabrication machine, reduced variability in appliance accuracy and residual stress can be achieved.

Optionally, the direct fabrication methods described herein allow for fabrication of an appliance including multiple materials, referred to herein as “multi-material direct fabrication.” In some embodiments, a multi-material direct fabrication method involves concurrently forming an object from multiple materials in a single manufacturing step. For instance, a multi-tip extrusion apparatus can be used to selectively dispense multiple types of materials from distinct material supply sources in order to fabricate an object from a plurality of different materials. Such methods are described in U.S. Pat. No. 6,749,414, the disclosure of which is incorporated herein by reference in its entirety. Alternatively or in combination, a multi-material direct fabrication method can involve forming an object from multiple materials in a plurality of sequential manufacturing steps. For instance, a first portion of the object can be formed from a first material in accordance with any of the direct fabrication methods herein, then a second portion of the object can be formed from a second material in accordance with methods herein, and so on, until the entirety of the object has been formed.

Direct fabrication can provide various advantages compared to other manufacturing approaches. For instance, in contrast to indirect fabrication, direct fabrication permits production of an orthodontic appliance without utilizing any molds or templates for shaping the appliance, thus reducing the number of manufacturing steps involved and improving the resolution and accuracy of the final appliance geometry. Additionally, direct fabrication permits precise control over the three-dimensional geometry of the appliance, such as the appliance thickness. Complex structures and/or auxiliary components can be formed integrally as a single piece with the appliance shell in a single manufacturing step, rather than being added to the shell in a separate manufacturing step. In some embodiments, direct fabrication is used to produce appliance geometries that would be difficult to create using alternative manufacturing techniques, such as appliances with very small or fine features, complex geometric shapes, undercuts, interproximal structures, shells with variable thicknesses, and/or internal structures (e.g., for improving strength with reduced weight and material usage). For example, in some embodiments, the direct fabrication approaches herein permit fabrication of an orthodontic appliance with feature sizes of less than or equal to about 5 μm, or within a range from about 5 μm to about 50 μm, or within a range from about 20 μm to about 50 μm.

The direct fabrication techniques described herein can be used to produce appliances with substantially isotropic material properties, e.g., substantially the same or similar strengths along all directions. In some embodiments, the direct fabrication approaches herein permit production of an orthodontic appliance with a strength that varies by no more than about 25%, about 20%, about 15%, about 10%, about 5%, about 1%, or about 0.5% along all directions. In some embodiments, the direct fabrication techniques described herein can be used to produce appliances with substantially anisotropic material properties (e.g., having substantially different strengths along all directions). In some embodiments, the direct fabrication techniques described herein can produce an orthodontic appliance having a strength that varies by more than 10%, more than 15%, more than 20%, or more than 25% along all directions, but in a controlled manner. Additionally, the direct fabrication approaches herein can be used to produce orthodontic appliances at a faster speed compared to other manufacturing techniques. In some embodiments, the direct fabrication approaches herein allow for production of an orthodontic appliance in a time interval less than or equal to about 1 hour, about 30 minutes, about 25 minutes, about 20 minutes, about 15 minutes, about 10 minutes, about 5 minutes, about 4 minutes, about 3 minutes, about 2 minutes, about 1 minutes, or about 30 seconds. Such manufacturing speeds allow for rapid “chair-side” production of customized appliances, e.g., during a routine appointment or checkup.

In some embodiments, the direct fabrication methods described herein implement process controls for various machine parameters of a direct fabrication system or device in order to ensure that the resultant appliances are fabricated with a high degree of precision. Such precision can be beneficial for ensuring accurate delivery of a desired force system to the teeth in order to effectively elicit tooth movements. Process controls can be implemented to account for process variability arising from multiple sources, such as the material properties, machine parameters, environmental variables, and/or post-processing parameters.

Material properties may vary depending on the properties of raw materials, purity of raw materials, and/or process variables during mixing of the raw materials. In many embodiments, resins or other materials for direct fabrication should be manufactured with tight process control to ensure little variability in photo-characteristics, material properties (e.g., viscosity, surface tension), physical properties (e.g., modulus, strength, elongation) and/or thermal properties (e.g., glass transition temperature, heat deflection temperature). Process control for a material manufacturing process can be achieved with screening of raw materials for physical properties and/or control of temperature, humidity, and/or other process parameters during the mixing process. By implementing process controls for the material manufacturing procedure, reduced variability of process parameters and more uniform material properties for each batch of material can be achieved. Residual variability in material properties can be compensated with process control on the machine, as discussed further herein.

Machine parameters can include curing parameters. For digital light processing (DLP)-based curing systems, curing parameters can include power, curing time, and/or grayscale of the full image. For laser-based curing systems, curing parameters can include power, speed, beam size, beam shape and/or power distribution of the beam. For printing systems, curing parameters can include material drop size, viscosity, and/or curing power. These machine parameters can be monitored and adjusted on a regular basis (e.g., some parameters at every 1-x layers and some parameters after each build) as part of the process control on the fabrication machine. Process control can be achieved by including a sensor on the machine that measures power and other beam parameters every layer or every few seconds and automatically adjusts them with a feedback loop. For DLP machines, gray scale can be measured and calibrated at the end of each build. In addition, material properties and/or photo-characteristics can be provided to the fabrication machine, and a machine process control module can use these parameters to adjust machine parameters (e.g., power, time, gray scale, etc.) to compensate for variability in material properties. By implementing process controls for the fabrication machine, reduced variability in appliance accuracy and residual stress can be achieved.

In many embodiments, environmental variables (e.g., temperature, humidity, Sunlight or exposure to other energy/curing source) are maintained in a tight range to reduce variable in appliance thickness and/or other properties. Optionally, machine parameters can be adjusted to compensate for environmental variables.

In many embodiments, post-processing of appliances includes cleaning, post-curing, and/or support removal processes. Relevant post-processing parameters can include purity of cleaning agent, cleaning pressure and/or temperature, cleaning time, post-curing energy and/or time, and/or consistency of support removal process. These parameters can be measured and adjusted as part of a process control scheme. In addition, appliance physical properties can be varied by modifying the post-processing parameters. Adjusting post-processing machine parameters can provide another way to compensate for variability in material properties and/or machine properties.

The configuration of the orthodontic appliances herein can be determined according to a treatment plan for a patient, e.g., a treatment plan involving successive administration of a plurality of appliances for incrementally repositioning teeth. Computer-based treatment planning and/or appliance manufacturing methods can be used in order to facilitate the design and fabrication of appliances. For instance, one or more of the appliance components described herein can be digitally designed and fabricated with the aid of computer-controlled manufacturing devices (e.g., computer numerical control (CNC) milling, computer-controlled rapid prototyping such as 3D printing, etc.). The computer-based methods presented herein can improve the accuracy, flexibility, and convenience of appliance fabrication.

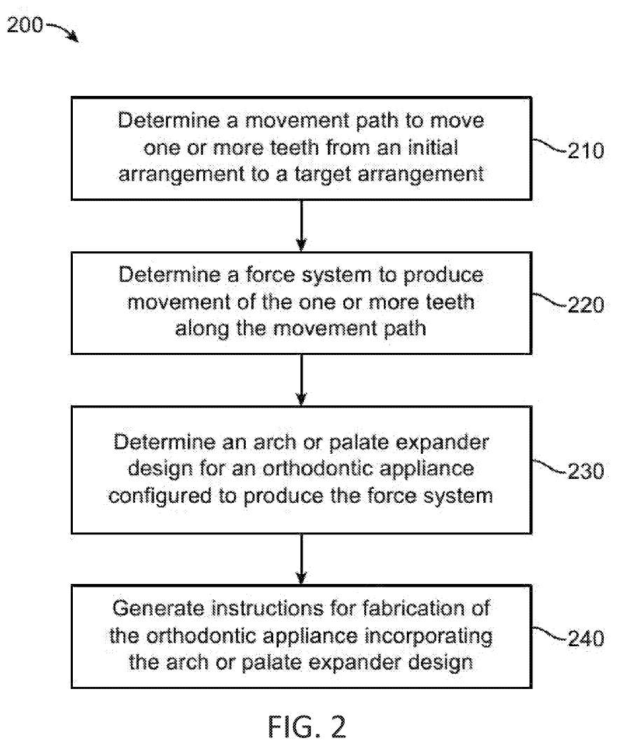

FIG. 2 illustrates a method (200) for designing an orthodontic appliance to be produced by direct fabrication, in accordance with embodiments. The method (200) can be applied to any embodiment of the orthodontic appliances described herein. Some or all of the steps of the method (200) can be performed by any suitable data processing system or device, e.g., one or more processors configured with suitable instructions.

In step (210), a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In step (220), a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients will typically require lower forces to expand the suture than older patients, as the suture has not yet fully formed.

In step (230), an arch or palate expander design for an orthodontic appliance configured to produce the force system is determined. Determination of the arch or palate expander design, appliance geometry, material composition, and/or properties can be performed using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, Calif. For creating finite element models and analyzing them, program products from a number of vendors can be used, including finite element analysis packages from ANSYS, Inc., of Canonsburg, Pa., and SUMULIA(Abaqus) software products from Dassault Systèmes of Waltham, Mass.

Optionally, one or more arch or palate expander designs can be selected for testing or force modeling. As noted above, a desired tooth movement, as well as a force system required or desired for eliciting the desired tooth movement, can be identified. Using the simulation environment, a candidate arch or palate expander design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In step (240), instructions for fabrication of the orthodontic appliance incorporating the arch or palate expander design are generated. The instructions can be configured to control a fabrication system or device in order to produce the orthodontic appliance with the specified arch or palate expander design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Method (200) may comprise additional steps: 1) The upper arch and palate of the patient is scanned intraorally to generate three-dimensional data of the palate and upper arch; 2) The three-dimensional shape profile of the appliance is determined to provide a gap and teeth engagement structures as described herein.

Although the above steps show a method (200) of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method (200) may be performed with any suitable fabrication system or device, such as the embodiments described herein. Some of the steps may be optional, and the order of the steps can be varied as desired.

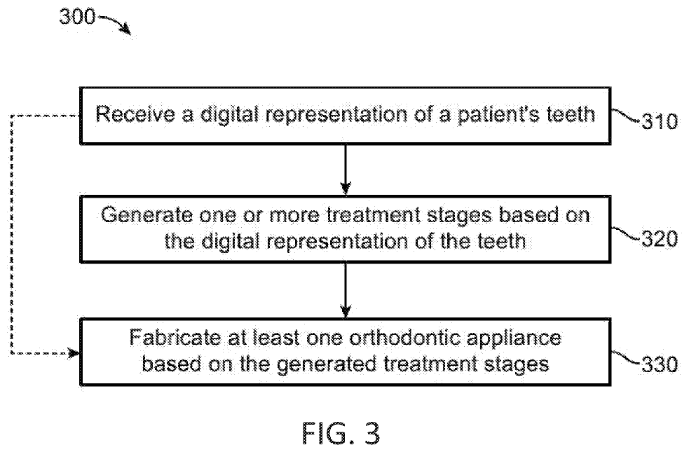

FIG. 3 illustrates a method (300) for digitally planning an orthodontic treatment and/or design or fabrication of an appliance, in accordance with embodiments. The method (300) can be applied to any of the treatment procedures described herein and can be performed by any suitable data processing system.

In step (310), a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In step (320), one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In step (330), at least one orthodontic appliance is fabricated based on the generated treatment stages. For example, a set of appliances can be fabricated, each shaped according a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 3, design and/or fabrication of an orthodontic appliance, and perhaps a particular orthodontic treatment, may include use of a representation of the patient's teeth (e.g., receive a digital representation of the patient's teeth (310)), followed by design and/or fabrication of an orthodontic appliance based on a representation of the patient's teeth in the arrangement represented by the received representation.

### On-Track Treatment

In some embodiments, this disclosure provides a method for repositioning a patient's teeth, the method comprising applying an orthodontic appliance disclosed herein to at least one of a patient's teeth, and moving at least one of the patient's teeth toward an intermediate arrangement or a final tooth arrangement.

In some embodiments, this disclosure provides a method of repositioning a patient's teeth, the method comprising:
generating a treatment plan for a patient, the plan comprising a plurality of intermediate tooth arrangements for moving teeth along a treatment path from an initial arrangement toward a final arrangement;
producing a 3D printed orthodontic appliance comprising a material as further described herein; and
moving on-track, with the orthodontic appliance, at least one of the patient's teeth toward an intermediate arrangement or a final tooth arrangement.

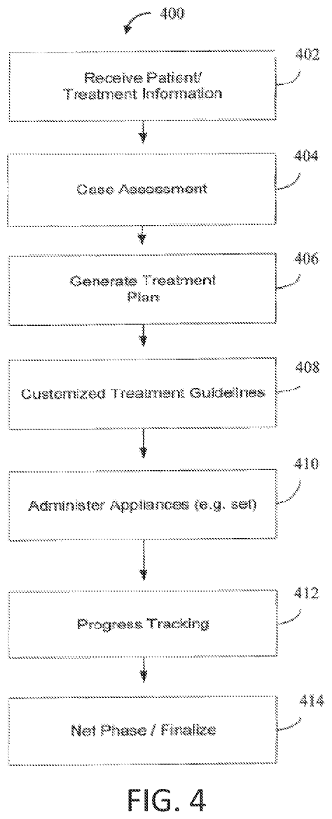

Referring to FIG. 4, a process (400) according to the present disclosure is illustrated. Individual aspects of the process are discussed in further detail below. The process includes receiving information regarding the orthodontic condition of the patient and/or treatment information (402), generating an assessment of the case (404), and generating a treatment plan for repositioning a patient's teeth (406). Briefly, a patient/treatment information will include obtaining data comprising an initial arrangement of the patient's teeth, which typically includes obtaining an impression or scan of the patient's teeth prior to the onset of treatment and can further include identification of one or more treatment goals selected by the practitioner and/or patient. A case assessment can be generated (404) so as to assess the complexity or difficulty of moving the particular patient's teeth in general or specifically corresponding to identified treatment goals, and may further include practitioner experience and/or comfort level in administering the desired orthodontic treatment. In some cases, however, the assessment can include simply identifying particular treatment options (e.g., appointment planning, progress tracking, etc.) that are of interest to the patient and/or practitioner. The information and/or corresponding treatment plan will include identifying a final or target arrangement of the patient's teeth that is desired, as well as a plurality of planned successive or intermediary tooth arrangements for moving the teeth along a treatment path from the initial arrangement toward the selected final or target arrangement.

The process further includes generating customized treatment guidelines (408). The treatment plan typically includes multiple phases of treatment, with a customized set of treatment guidelines generated that correspond to a phase of the treatment plan. The guidelines will include detailed information on timing and/or content (e.g., specific tasks) to be completed during a given phase of treatment, and will be of sufficient detail to guide a practitioner, including a less experienced practitioner or practitioner relatively new to the particular orthodontic treatment process, through the phase of treatment. Since the guidelines are designed to specifically correspond to the treatment plan and provide guidelines on activities specifically identified in the treatment information and/or generated treatment plan, the guidelines are said to be customized. The customized treatment guidelines are then provided to the practitioner so as to help instruct the practitioner as how to deliver a given phase of treatment. As set forth above, appliances can be generated based on the planned arrangements and will be provided to the practitioner and ultimately administered to the patient (410). The appliances are typically provided and/or administered in sets or batches of appliances, such as 2, 3, 4, 5, 6, 7, 8, 9, or more appliances, but are not limited to any particular administrative scheme. Appliances can be provided to the practitioner concurrently with a given set of guidelines, or appliances and guidelines can be provided separately.

After the treatment according to the plan begins and following administration of appliances to the patient, treatment progress tracking, e.g., by teeth matching, is done to assess a current and actual arrangement of the patient's teeth compared to a planned arrangement (412). If the patient's teeth are determined to be “on-track” and progressing according to the treatment plan, then treatment progresses as planned and treatment progresses to the next stage of treatment (414). If the patient's teeth have substantially reached the initially planned final arrangement, then treatment progresses to the final stages of treatment (414). Where the patient's teeth are determined to be tracking according to the treatment plan, but have not yet reached the final arrangement, the next set of appliances can be administered to the patient.

The threshold difference values of a planned position of teeth to actual positions selected as indicating that a patient's teeth have progressed on-track are provided below in Table 1. If a patient's teeth have progressed at or within the threshold values, the progress is considered to be on-track. If a patient's teeth have progressed beyond the threshold values, the progress is considered to be off-track.

TABLE 1

| Type Movement | Difference Actual/Planned | |
|---|---|---|
| Rotations | | |
| Upper Central Incisors | 9 | degrees |
| Upper Lateral Incisors | 11 | degrees |
| Lower Incisors | 11 | degrees |
| Upper Cuspids | 11 | degrees |
| Lower Cuspids | 9.25 | degrees |
| Upper Bicuspids | 7.25 | degrees |
| Lower First Bicuspid | 7.25 | degrees |
| Lower Second Bicuspid | 7.25 | degrees |
| Molars | 6 | degrees |
| Extrusion | | |
| Anterior | 0.75 | mm |
| Posterior | 0.75 | mm |
| Intrusion | | |
| Anterior | 0.75 | mm |
| Posterior | 0.75 | mm |
| Angulation | | |
| Anterior | 5.5 | degrees |
| Posterior | 3.7 | degrees |
| Inclination | | |
| Anterior | 5.5 | degrees |
| Posterior | 3.7 | degrees |
| Translation | | |
| BL Anterior | 0.7 | mm |
| BL Posterior Cuspids | 0.9 | mm |
| MD Anterior | 0.45 | mm |
| MD Cuspids | 0.45 | mm |
| MD Posterior | 0.5 | mm |

The patient's teeth are determined to be on track by comparison of the teeth in their current positions with teeth in their expected or planned positions, and by confirming the teeth are within the parameter variance disclosed in Table 1. If the patient's teeth are determined to be on track, then treatment can progress according to the existing or original treatment plan. For example, a patient determined to be progressing on track can be administered one or more subsequent appliances according to the treatment plan, such as the next set of appliances. Treatment can progress to the final stages and/or can reach a point in the treatment plan where bite matching is repeated for a determination of whether a patient's teeth are progressing as planned or if the teeth are off track.

In some embodiments, as further disclosed herein, this disclosure provides methods of treating a patient using a 3D printed orthodontic appliance. In certain embodiments, the method of repositioning a patient's teeth (or, in some embodiments, a singular tooth) comprises: generating a treatment plan for the patient, the plan comprising tooth arrangements for moving teeth along a treatment path from an initial arrangement toward a final arrangement; producing a 3D printed orthodontic appliance; and moving on-track, with the orthodontic appliance, at least one of the patient's teeth toward an intermediate arrangement or a final tooth arrangement. In some embodiments, producing the 3D printed orthodontic appliance uses the resins disclosed further herein. On-track performance can be determined, e.g., from Table 1, above.

In some embodiments, the method further comprises tracking the progression of the patient's teeth along the treatment path after administration of the orthodontic appliance. In certain embodiments, the tracking comprises comparing a current arrangement of the patient's teeth to a planned arrangement of the teeth. As a non-limiting example, following the initial administration of the orthodontic appliance, a period of time passes (e.g., two weeks), a comparison of the now-current arrangement of the patient's teeth (i.e., at two weeks of treatment) can be compared with the teeth arrangement of the treatment plan. In some embodiments, the progression can also be tracked by comparing the current arrangement of the patient's teeth with the initial configuration of the patient's teeth. The period of time can be, for example, greater than 3 days, greater than 4 days, greater than 5 days, greater than 6 days, greater than 7 days, greater than 8 days, greater than 9 days, greater than 10 days, greater than 11 days, greater than 12 days, greater than 13 days, greater than 2 weeks, greater than 3 weeks, greater than 4 weeks, or greater than 2 months. In some embodiments, the period of time can be from at least 3 days to at most 4 weeks, from at least 3 days to at most 3 weeks, from at least 3 days to at most 2 weeks, from at least 4 days to at most 4 weeks, from at least 4 days to at most 3 weeks, or from at least 4 days to at most 2 weeks. In certain embodiments, the period of time can restart following the administration of a new orthodontic appliance.

In some embodiments, greater than 50%, greater than 55%, greater than 60%, greater than 65%, greater than 70%, greater than 75%, greater than 80%, greater than 85%, greater than 90%, greater than 91%, greater than 92%, greater than 93%, greater than 94%, greater than 95%, greater than 96%, greater than 97%, greater than 98%, or greater than 99% of the patient's teeth are on track with the treatment plan after a period of time of using an orthodontic appliance as disclosed further herein. In some embodiments, the period of time is 3 days, 4 days, 5 days, 6 days, 7 days, 8 days, 9 days, 10 days, 11 days, 12 days, 13 days, 2 weeks, 3 weeks, 4 weeks, or greater than 4 weeks.

### Device Properties

In some embodiments of the method disclosed above, the 3D printed orthodontic appliance has a retained repositioning force (i.e., the repositioning force after the orthodontic appliance has been applied to or worn by the patient over a period of time), and the retained repositioning force to at least one of the patient's teeth after the period of time is at least 10%, at least 20%, at least 30%, at least 40%, at least 50%, at least 55%, at least 60%, at least 65%, at least 70%, at least 75%, at least 80%, at least 85%, at least 90%, at least 95%, at least 96%, at least 97%, at least 98%, or at least 99% of the repositioning force initially provided to the at least one of the patient's teeth (i.e., with initial application of the orthodontic appliance). In some embodiments, the period of time is 3 days, 4 days, 5 days, 6 days, 7 days, 8 days, 9 days, 10 days, 11 days, 12 days, 13 days, 2 weeks, 3 weeks, 4 weeks, or greater than 4 weeks.

In some embodiments, the orthodontic appliances disclosed herein can provide on-track movement of at least one of the patient's teeth. On-track movement has been described further herein, e.g., at Table 1. In some embodiments, the orthodontic appliances disclosed herein can be used to achieve on-track movement of at least one of the patient's teeth to an intermediate tooth arrangement. In some embodiments, the orthodontic appliances disclosed herein can be used to achieve on-track movement of at least one of the patient's teeth to a final tooth arrangement.

In some embodiments, prior to moving on-track, with the orthodontic appliance, at least one of the patient's teeth toward the intermediate arrangement or the final tooth arrangement, the orthodontic appliance comprises a first flexural stress; and after achieving on-track the movement of the at least one of the patient's teeth to the intermediate arrangement or the final tooth arrangement, the orthodontic appliance comprises a second flexural stress. In some embodiments, the second flexural stress is from 80 MPa to 0.5 MPa, from 70 MPa to 0.5 MPa, from 60 MPa to 1 MPa, from 50 MPa to 1 MPa, from 40 MPa to 1 MPa, from 30 MPa to 2 MPa, from 25 MPa to 2 MPa, from 20 MPa to 2 MPa, from 15 MPa to 2 MPa, or from 15 MPa to 0.01 MPa. In some embodiments, flexural stress is assessed according to ASTM E328. In some embodiments, the time period between an initial placement of the orthodontic appliance to the patient's teeth and achieving on-track the movement is 3 days, 4 days, 5 days, 6 days, 7 days, 8 days, 9 days, 10 days, 11 days, 12 days, 13 days, two weeks, or less than two weeks.

In some embodiments, prior to moving on-track, with the orthodontic appliance, at least one of the patient's teeth toward the intermediate arrangement or the final tooth arrangement, the orthodontic appliance comprises a first emission wavelength; and after achieving on-track the movement of the at least one of the patient's teeth to the intermediate arrangement or the final tooth arrangement, the orthodontic appliance comprises a second emission wavelength. In some embodiments, the emission wavelength is determined while the orthodontic appliance is on the patient's teeth. In some embodiments, the time period between an initial placement of the orthodontic appliance to the patient's teeth and achieving on-track the movement is determined by the emission wavelength measured of the orthodontic appliance. In some embodiments, the time period between an initial placement of the orthodontic appliance to the patient's teeth and achieving on-track the movement is 3 days, 4 days, 5 days, 6 days, 7 days, 8 days, 9 days, 10 days, 11 days, 12 days, 13 days, two weeks, or less than two weeks, after measuring an emission wavelength of the orthodontic appliance.

In some embodiments, prior to moving, with the orthodontic appliance, at least one of the patient's teeth toward an intermediate arrangement or a final tooth arrangement, the orthodontic appliance has characteristics which are retained following the use of the orthodontic appliance.

In some embodiments, prior to moving, with the orthodontic appliance, an emission wavelength is measured prior to moving to next stage of treatment.

As provided herein, the methods disclosed can use the orthodontic appliances further disclosed herein. Said orthodontic appliances can be directly fabricated using, e.g., the resins disclosed herein. In certain embodiments, the direct fabrication comprises cross-linking the resin.

The appliances formed from the resins disclosed herein provide improved durability, strength, flexibility, and optical properties which in turn improve the rate of on-track progression in treatment plans. In some embodiments, greater than 60%, greater than 70%, greater than 80%, greater than 90%, or greater than 95% of patients treated with the orthodontic appliances disclosed herein (e.g., an aligner) are classified as on-track in a given treatment stage. In certain embodiments, greater than 60%, greater than 70%, greater than 80%, greater than 90%, or greater than 95% of patients treated with the orthodontic appliances disclosed herein (e.g., an aligner) have greater than 50%, greater than 55%, greater than 60%, greater than 65%, greater than 70%, greater than 75%, greater than 80%, greater than 85%, greater than 90%, or greater than 95% of their tooth movements classified as on-track.

As disclosed further herein, the resins, polymeric materials, and devices contain favorable characteristics that, at least in part, stem from the incorporation of force probes. These resins, polymeric materials, and devices can have optical properties that render them superior to other materials which lack force probe incorporation. The resins and polymeric materials disclosed herein can be used for devices within the field of orthodontics, as well as outside the field of orthodontics.

1-170: (canceled)

171. An orthodontic appliance comprising:
a polymeric material; and
a force probe incorporated into the polymeric material, wherein the force probe:
when in an unstrained configuration comprises a first emission spectrum; and
when in a strained configuration comprises a second emission spectrum, wherein the first emission spectrum and the second emission spectrum are distinct from one another, wherein a transition between the unstrained configuration and the strained configuration occurs when a force is applied to the orthodontic appliance.

172. The orthodontic appliance of claim 171, wherein the force comprises a mechanical force comprising application of the orthodontic appliance to a patient's teeth.

173. The orthodontic appliance of claim 171, wherein the force probe comprises a detectable fluorophore having an emission spectrum.

174. The orthodontic appliance of claim 173, wherein the detectable fluorophore has a first detectable emission responsive to a first contact force, and a second detectable emission responsive to a second contact force.

175. The orthodontic appliance of claim 174, wherein a transition between the first detectable emission and the second detectable emission occurs when a mechanical force is applied to the orthodontic appliance.

176. The orthodontic appliance of claim 171, wherein the orthodontic appliance comprises a localized region, the localized region comprising:
the force probe;
at least some of the polymeric material; and
an area less than 100 nm in any direction from the force probe.

177. The orthodontic appliance of claim 176, wherein the force probe:
when in an unstrained configuration comprises a first emission spectrum; and
when in a strained configuration comprises a second emission spectrum, wherein the first emission spectrum and the second emission spectrum are distinct from one another, and wherein a transition between the unstrained configuration and the strained configuration occurs when a mechanical force is applied to the orthodontic appliance.

178. The orthodontic appliance of claim 177, wherein the mechanical force comprises a force greater than 1 pN applied to the localized region.

179. The orthodontic appliance of claim 171, wherein the force probe further comprises a photon absorber.

180. The orthodontic appliance of claim 179, wherein the photon absorber is a quencher, wherein the quencher comprises 4-(dimethylaminoazo)benzene-4-carboxylic acid, a DDQ quencher, a BHQ quencher, a QSY quencher, a derivative thereof, or a combination thereof.

181. The orthodontic appliance of claim 179, wherein the photon absorber is a second fluorophore having an absorption spectrum that overlaps with an emission spectrum of the detectable fluorophore.

182. The orthodontic appliance of claim 181, wherein the second fluorophore comprises a xanthene derivative, a cyanine derivative, a squaraine derivative, a naphthalene derivative, a coumarin derivative, an oxadiazole derivative, an anthracene derivative, a pyrene derivative, an oxazine derivative, an acridine derivative, an arylmethine derivative, a tetrapyrrole derivative, or a combination thereof.

183. The orthodontic appliance of claim 179, wherein the photon absorber is coupled to the detectable fluorophore.

184. The orthodontic appliance of claim 183, wherein the force probe further comprises a flexible tether, and wherein the photon absorber and the detectable fluorophore are each coupled to the flexible tether.

185. The orthodontic appliance of claim 184, wherein the flexible tether comprises a polymer chain or a peptide chain.

186. The orthodontic appliance of claim 171, wherein the detectable fluorophore comprises a single-molecule force probe.

187. The orthodontic appliance of claim 186, wherein the single-molecule force probe is selected from the group consisting of a spiropyran, an aromatic disulfide, a nitroxyl, a stilbene, and a dye.

188. The orthodontic appliance of claim 171, wherein the force probe is coupled to the polymeric material.

189. The orthodontic appliance of claim 171, wherein the polymeric material comprises a plurality of additively formed layers.

190. The orthodontic appliance of claim 171, wherein the polymeric material comprises a thermoplastic material.

191. An orthodontic appliance comprising:
a polymeric material; and
means for probing an emission spectrum of the polymeric material, wherein:
the means for probing comprises a first emission spectrum when in an unstrained configuration; and
the means for probing comprises a second emission spectrum when in a strained configuration, wherein the first emission spectrum and the second emission spectrum are distinct from one another, wherein a transition between the unstrained configuration and the strained configuration occurs when a force is applied to the orthodontic appliance.
